(19) United States
(12) Patent Application Publication
(10) Pub. No.: US 2024/0080134 A1
(43) Pub. Date: Mar. 7, 2024

(54) BLUETOOTH PACKET LOSS DATA RECEIVING AND SENDING METHOD, CIRCUIT, AUDIO PLAYBACK DEVICE, AND SYSTEM

(71) Applicant: ZHUHAI JIELI TECHNOLOGY CO., LTD, Zhuhai (CN)

(72) Inventors: Jiajun Zhu, Zhuhai (CN); Haitao Huang, Zhuhai (CN); Qiming Zhang, Zhuhai (CN); Xiangjun Hu, Zhuhai (CN); Guangjun Luo, Zhuhai (CN); Ziming Huang, Zhuhai (CN); Xin Yu, Zhuhai (CN)

(21) Appl. No.: 18/506,203

(22) Filed: Nov. 10, 2023

Related U.S. Application Data
(63) Continuation of application No. PCT/CN2021/132495, filed on Nov. 23, 2021.

(30) Foreign Application Priority Data
Jul. 22, 2021 (CN) 202110830813.3

(51) Int. Cl. H04L 1/08; G06F 3/16; H04L 1/00

(52) U.S. Cl. CPC H04L 1/08; G06F 3/165; H04L 1/0036

(57) ABSTRACT

A method, circuit, audio playback device, and system of sending and receiving Bluetooth packet loss data is disclosed. The method includes: step S100, receiving a forwarding request sent by a second audio playback device in a receiving state; step S200, monitoring the retransmission information of an audio source device retransmitting current audio data on Link 1 according to the forwarding request; step S300, determining whether the retransmission information is monitored; step S400, switching from the receiving state to a sending state; and step S500, forwarding the current audio data to the second audio playback device through Link 2 in accordance with the time sequence of the audio source device retransmitting the current audio data. The signal can be provided to the second audio playback device from different locations.

### CROSS REFERENCE TO RELATED APPLICATIONS

The present application is a Continuation Application of PCT Application No. PCT/CN2021/132495 filed on Nov. 23, 2021, which claims the benefit of Chinese Patent Application No. 202110830813.3 filed on Jul. 22, 2021. All the above are hereby incorporated by reference in their entirety.

### TECHNICAL FIELD

This application relates to the field of audio communication technologies, and specifically to a Bluetooth packet loss data receiving and sending method, circuit, audio playback device, and system.

### BACKGROUND

Currently, True Wireless Stereo (TWS) is quite popular. This is because TWS implements wireless transmission between headphones and mobile phone, bringing great convenience to consumers.

When one side of the TWS headphones fails to receive the audio data packet sent by the mobile phone, the other side successfully receives the audio data packet sent by the mobile phone; in a solution, the successful side then becomes a forwarder in the subsequent slots, and the failed side becomes a receiver in the subsequent slots, to receive the audio data forwarded by the forwarder, thus correcting the error of the failed received audio data packet. In another solution, once one side loses an audio data packet and the other side receives the audio data packet correctly, the side which is serving as a main speaker (or earbud) will reply to the mobile phone with a Negative Acknowledgment, and request the mobile phone to retransmit an audio data packet in a next slot, and the side which lost the audio data packet will re-receives the audio data packet retransmitted by the mobile phone in the next slot for error correction.

FIG. 1 is a schematic diagram of an example communication structure of a dual wireless network in the related art. A mobile phone, a left earbud, and a right earbud in the dual wireless network are located at different positions in space. The left and right earbuds are separated by the user's head, and there may be other obstacles (e.g. human body, etc.) between the mobile phone and the left and right earbuds. Therefore, whether using the method of one side earbud forwarding, or the method of the mobile phone retransmission for error correction, it is impossible to overcome the serious threat of deep fading caused by the human body to stability of TWS in a wireless environment.

Therefore, for packet loss error correction in the dual wireless Bluetooth communication network, how to improve the data receiving method and increase the data error correction rate under the premise of the existence of deep fading signal caused by the human body has become an urgent technical problem to be solved.

### SUMMARY

A main object of the present invention is to provide a method, circuit, audio playback device, and system of sending and receiving Bluetooth packet loss data, to improve the data receiving method and increase the data error correction rate in the presence of deep fading signal caused by the human body.

To achieve the foregoing objective, the present invention uses the following technical solutions.

In a first aspect, an embodiment of the present invention discloses a method of sending Bluetooth packet loss data, applied to a first audio playback device, wherein the first audio playback device and a second audio playback device form an audio playback device pair, and the first audio playback device and the second audio playback device are configured to separately receive the audio data from an audio source device. The method includes:
step S100, receiving, in a receiving state, a forwarding request from the second audio playback device, wherein the forwarding request indicates that the second audio playback device fails to receive the current audio data from the audio source device;
step S200, monitoring, on Link 1 based on the forwarding request, retransmission information of the audio source device retransmitting the current audio data packet, wherein Link 1 is a link on which the audio source device sends the audio data;
step S300, determining whether the retransmission information is monitored; if the retransmission information is monitored, step S400 and step S500 are performed sequentially;
step S400, switching from the receiving state to a sending state; and
step S500, forwarding the current audio data to the second audio playback device via Link 2 in accordance with the time sequence of the audio source device retransmitting the current audio data, wherein Link 2 is an interactive link between the first audio playback device and the second audio playback device.

Optionally, in step S500, the current audio data is forwarded by using the same preset frequency band as that of the audio source device.

Optionally, step S300 includes:
step S310, extracting a first packet header information that is stored locally, wherein the first packet header information is the packet header information of the audio source device;
step S320, performing information extraction on the signal monitored on Link 1 to obtain a second packet header information;
step S330, performing a correlation operation on the first packet header information and the second packet header information to obtain a correlation result; and
step S340, determining whether the correlation result is greater than a preset value, and determining, if the correlation result is greater than the preset value, that the retransmission information is monitored.

Optionally, the packet header information of the audio source device includes a front part and a rear part, with the rear part lagging behind the front part in time sequence; and the first packet header information is the front part, and the second packet header information is data information corresponding to the length of the front part.

Optionally, in step S500, after switching to the sending state, the rear part and the current audio data are forwarded sequentially immediately, to keep in synchronization with the time sequence of the audio source device retransmitting the rear part and the current audio data.

In a second aspect, an embodiment of the present invention discloses a method of receiving Bluetooth packet loss data, applied to a second audio playback device, wherein a first audio playback device and the second audio playback device form an audio playback device pair, and the first audio playback device and the second audio playback device are configured to separately receive audio data from an audio source device. The method includes:
step R100, prompting, when the second audio playback device fails to receive the current audio data sent by the audio source device, the first audio playback device and the audio source device that the second audio playback device fails to receive the current audio data;
step R200, monitoring, on Link 1, retransmission information of the audio source device retransmitting a current audio data packet, wherein Link 1 is a link on which the audio source device sends audio data;
step R300, monitoring, on Link 2, forwarding information of the first audio playback device forwarding the current audio data, wherein Link 2 is an interactive link between the first audio playback device and the second audio playback device;
step R400, determining whether the retransmission information is monitored, to obtain a retransmission determination result;
step R500, determining whether the forwarding information is monitored, to obtain a forwarding determination result; and
step R600, selecting, according to the retransmission determination result and the forwarding determination result, Link 1 and/or Link 2 as the target link(s) to receive the current audio data, to perform error correction on current packet loss data.

Optionally, step R400 includes:
step R410, extracting first packet header information that is stored locally, wherein the first packet header information is packet header information of the audio source device;
step R420, performing information extraction on the signal monitored on Link 1 to obtain second packet header information;
step R430, performing a correlation operation on the first packet header information and the second packet header information to obtain a retransmission correlation result; and
step R440, determining whether the retransmission correlation result is greater than a preset value, and determining, if the retransmission correlation result is greater than the preset value, that the retransmission information is monitored.

Optionally, the packet header information of the audio source device includes a front part and a rear part, with the rear part lagging behind the front part in time sequence; and the first packet header information is the front part, and the second packet header information is data information corresponding to the length of the front part.

Optionally, the first packet header information is complete packet header information of the audio source device, and the second packet header information is at least a part of the complete packet header information.

Optionally, step R500 includes:
step R510, extracting third packet header information that is stored locally, wherein the third packet header information is packet header information of the audio source device;
step R520, performing information extraction on the signal monitored on Link 2 to obtain fourth packet header information;
step R530, performing a correlation operation on the third packet header information and the fourth packet header information to obtain a forwarding correlation result; and
step R540, determining whether the forwarding correlation result is greater than a preset value, and determining, if the forwarding correlation result is greater than the preset value, that the forwarding information is monitored.

Optionally, the packet header information of the audio source device includes a front part and a rear part, with the rear part lagging behind the front part in time sequence; and the third packet header information is the rear part, and the fourth packet header information is data information corresponding to the length of the rear part.

Optionally, step R600 includes:
selecting, when the retransmission determination result is that the retransmission information is monitored, Link 1 as a target link to receive the current audio data; or
selecting, when the forwarding determination result is that the forwarding information is monitored, Link 2 as a target link to receive the current audio data; or
selecting, when the retransmission determination result is that the retransmission information is monitored and the forwarding determination result is that the forwarding information is monitored, Link 1 and Link 2 as target links to receive the current audio data.

Optionally, the current audio data is received via the target link in the same preset frequency band.

In a third aspect, an embodiment of the present invention discloses a Bluetooth packet loss data sending apparatus, applied to a first audio playback device, wherein the first audio playback device and a second audio playback device form an audio playback device pair, and the first audio playback device and the second audio playback device are configured to separately receive audio data from an audio source device. The apparatus includes:
a request receiving module, configured to receive, in a receiving state, a forwarding request sent by the second audio playback device, wherein the forwarding request indicates that the second audio playback device fails to receive current audio data sent by the audio source device;
a retransmission monitoring module, configured to monitor, on Link 1 according to the forwarding request, retransmission information of the audio source device retransmitting a current audio data packet, wherein Link 1 is a link on which the audio source device sends audio data;
a retransmission determining module, configured to determine whether the retransmission information is monitored; if the retransmission information is monitored, a state switching module and a forwarding module are run sequentially;
the state switching module, configured to switch from the receiving state to a sending state; and
the forwarding module, configured to forward the current audio data to the second audio playback device via Link 2 in accordance with a time sequence of the audio source device retransmitting the current audio data, wherein Link 2 is an interactive link between the first audio playback device and the second audio playback device.

Optionally, the forwarding module is configured to forward the current audio data by using the same preset frequency band as that of the audio source device.

Optionally, the retransmission determining module includes:
a first extraction unit, configured to extract a first packet header information that is stored locally, wherein the first packet header information is packet header information of the audio source device;
a second extraction unit, configured to perform information extraction on the signal monitored on Link 1 to obtain a second packet header information;
a correlation operation unit, configured to perform a correlation operation on the first packet header information and the second packet header information to obtain a correlation result; and
a preset value determining unit, configured to determine whether the correlation result is greater than a preset value, and determine, if the correlation result is greater than the preset value, that the retransmission information is monitored.

Optionally, the packet header information of the audio source device includes a front part and a rear part, with the rear part lagging behind the front part in time sequence. The first packet header information is the front part, and the second packet header information is data information corresponding to the length of the front part.

Optionally, the forwarding module is configured to forward, after switching to the sending state, the rear part and the current audio data sequentially immediately, to keep in synchronization with the time sequence of the audio source device retransmitting the rear part and the current audio data.

In a fourth aspect, an embodiment of the present invention discloses a Bluetooth packet loss data receiving apparatus, applied to a second audio playback device, wherein a first audio playback device and the second audio playback device form an audio playback device pair, and the first audio playback device and the second audio playback device are configured to separately receive audio data from an audio source device. The apparatus includes:
a prompting module, configured to prompt, when the second audio playback device fails to receive a current audio data sent by the audio source device, the first audio playback device and the audio source device that the second audio playback device does not successfully receive the current audio data;
a first monitoring module, configured to monitor, on Link 1, retransmission information of the audio source device retransmitting the current audio data, wherein Link 1 is a link on which the audio source device sends audio data;
a second monitoring module, configured to monitor, on Link 2, forwarding information of the first audio playback device forwarding the current audio data, wherein Link 2 is an interactive link between the first audio playback device and the second audio playback device;
a first determining module, configured to determine whether the retransmission information is monitored, to obtain a retransmission determination result;
a second determining module, configured to determine whether the forwarding information is monitored, to obtain a forwarding determination result; and
a data receiving module, configured to select, according to the retransmission determination result and the forwarding determination result, Link 1 and/or Link 2 as a target link to receive the current audio data, to perform error correction on current packet loss data.

Optionally, the first determining module includes:
a first extraction unit, configured to extract a first packet header information that is stored locally, wherein the first packet header information is packet header information of the audio source device;
a second extraction unit, configured to perform information extraction on signal monitored on Link 1 to obtain a second packet header information;
a retransmission correlation operation unit, configured to perform a correlation operation on the first packet header information and the second packet header information to obtain a retransmission correlation result; and
a first determining unit, configured to determine whether the retransmission correlation result is greater than a preset value, and determine, if the retransmission correlation result is greater than the preset value, that the retransmission information is monitored.

Optionally, the packet header information of the audio source device includes a front part and a rear t part, with the rear part lagging behind the front part in time sequence. The first packet header information is the front part, and the second packet header information is data information corresponding to the length of the front part.

Optionally, the first packet header information is a complete packet header information of the audio source device, and the second packet header information is at least a part of the complete packet header information.

Optionally, the second determining module includes:
a third extraction unit, configured to extract a third packet header information that is stored locally, wherein the third packet header information is packet header information of the audio source device;
a fourth extraction unit, configured to perform information extraction on the signal monitored on Link 2 to obtain a fourth packet header information;
a forwarding correlation operation unit, configured to perform a correlation operation on the third packet header information and the fourth packet header information to obtain a forwarding correlation result; and
a second determining unit, configured to determine whether the forwarding correlation result is greater than a preset value, and determine, if the forwarding correlation result is greater than the preset value, that the forwarding information is monitored.

Optionally, the packet header information of the audio source device includes a front part and a rear part, with the rear part lagging behind the front part in time sequence. The third packet header information is the rear part, and the fourth packet header information is data information corresponding to the length of the rear part.

Optionally, the data receiving module is further configured to:
select, when the retransmission determination result is that the retransmission information is monitored, Link 1 as a target link to receive the current audio data; or
select, when the forwarding determination result is that the forwarding information is monitored, Link 2 as a target link to receive the current audio data; or
select, when the retransmission determination result is that the retransmission information is monitored and the forwarding determination result is that the forwarding information is monitored, Link 1 and Link 2 as the target links to receive the current audio data.

Optionally, the current audio data is received on the target link in the same preset frequency band.

In a fifth aspect, an embodiment of the present invention discloses a Bluetooth communication transmitter circuit, applied to a first audio playback device, wherein the first audio playback device and a second audio playback device form an audio playback device pair, and the first audio playback device and the second audio playback device are configured to separately receive audio data from an audio source device. The Bluetooth communication transmitter circuit includes:
an information operation module, storing a first packet header information locally, wherein the first packet header information is packet header information of the audio source device;
an RF receiver apparatus, having an input end connected to a Bluetooth antenna, an output end connected to the information operation module; and wherein the RF receiver apparatus is configured to monitor, through the Bluetooth antenna, retransmission information of the audio source device retransmitting an audio data packet to obtain a second packet header information, wherein the second packet header information is packet header information of a signal received by the RF receiver apparatus; and
a transmitter module, connected to the information operation module, wherein the transmitter module is configured to forward, based on a forwarding drive signal outputted by the information operation module, the current audio data to the second audio playback device in accordance with a time sequence of the audio source device retransmitting the current audio data; and
the information operation module, configured to perform a correlation operation on the first packet header information and the second packet header information to obtain a correlation result, and output the forwarding drive signal to the transmitter module when the correlation result is greater than a preset value.

Optionally, the transmitter module is configured to forward the current audio data by using the same preset frequency band as that of the audio source device.

Optionally, the information operation module includes:
a first buffer, configured to store the first packet header information;
a second buffer, connected to the output end of the RF receiver apparatus, wherein the second buffer is configured to buffer the second packet header information; and
a correlation unit, having an input end connected to an output end of the first buffer and an output end of the second buffer, having an output end connected to the transmitter module; and wherein the correlation unit is configured to perform the correlation operation on the first packet header information and the second packet header information to obtain the correlation result, and output the forwarding drive signal to the transmitter module when the correlation result is greater than the preset value.

Optionally, the Bluetooth communication transmitter circuit further includes:
a switch, having one end connected to the Bluetooth antenna, and the other end selectively connected to the RF receiver apparatus or the transmitter module; wherein
when the other end of the switch is connected to the RF receiver apparatus, the RF receiver apparatus monitors the retransmission information through the Bluetooth antenna; and
when the other end of the switch is connected to the transmitter module, the transmitter module forwards the current audio data through the Bluetooth antenna.

Optionally, the packet header information of the audio source device includes a front part and a rear part, with the rear part lagging behind the front part in time sequence; and
the first buffer stores the front part; and
the second buffer is configured to buffer the data information in the second packet header information corresponding to the length of the front part.

Optionally, the transmitter module immediately forwards, after receiving the forwarding drive signal, the rear part and the current audio data sequentially, to keep in synchronization with the time sequence of the audio source device retransmitting the rear part and the current audio data.

Optionally, the packet header information of the audio source device is ACCESS CODE data or ACCESS ADDRESS data in a standard protocol.

In a sixth aspect, an embodiment of the present invention discloses a Bluetooth communication receiver circuit, applied to a second audio playback device, wherein a first audio playback device and the second audio playback device form an audio playback device pair, and the first audio playback device and the second audio playback device are configured to separately receive audio data from an audio source device. The Bluetooth communication receiver circuit includes:
an RF receiver apparatus, a common buffer, and an information processing module that are connected sequentially; wherein
when the second audio playback device fails to receive current audio data, the RF receiver apparatus monitors, on Link 1, retransmission information of the audio source device retransmitting the current audio data, and monitors, on Link 2, forwarding information of the first audio playback device forwarding the current audio data; wherein Link 1 is a link on which the audio source device sends audio data; and Link 2 is an interactive link between the first audio playback device and the second audio playback device;
the common buffer is configured to buffer data of Link 1 received when monitoring the retransmission information, and data of Link 2 received when monitoring the forwarding information, respectively;
the information processing module is configured to calculate data correlations based on the data of Link 1 and the data of Link 2 respectively and output a link selection control signal; and
the RF receiver apparatus is configured to select, according to the link selection control signal, Link 1 and/or Link 2 as the target link(s) to receive the current audio data, to perform error correction on current packet loss data, wherein the link selected to receive the current audio data is the link on which the information is monitored.

Optionally, the common buffer is configured to buffer second packet header information obtained when the RF receiver apparatus monitors the retransmission information, wherein the second packet header information is packet header information of the signal received by the RF receiver apparatus; and
the information processing module includes:
a first information processing unit, storing a first packet header information locally; wherein the first packet header information is packet header information of the audio source device; wherein the first information processing unit is configured to perform a correlation operation on the first packet header information and the second packet header information to obtain a retransmission correlation result, and determine, when the retransmission correlation result is greater than a first threshold, that Link 1 is the link on which the information is monitored.

Optionally, the first information processing unit includes:
a first buffer, storing the first packet header information;
a first correlation subunit, having an input end connected to an output end of the first buffer and an output end of the common buffer; wherein the first correlation subunit is configured to perform a correlation operation on the first packet header information and the second packet header information to obtain the retransmission correlation result, and determine, when the retransmission correlation result is greater than the first threshold, that Link 1 is the link on which information is monitored.

Optionally, the packet header information of the audio source device includes a front part and a rear part, with the rear part lagging behind the front part in time sequence; and
the first buffer is configured to store the front part, and the common buffer is configured to buffer data information corresponding to the length of the front part.

Optionally, the first packet header information is a complete packet header information of the audio source device; and
the first buffer is configured to store the complete packet header information; and the data buffered in the common buffer is at least a part of the complete packet header information.

Optionally, the information processing module includes:
a second information processing unit, configured to store a third packet header information locally, wherein the third packet header information is packet header information of the audio source device;
the common buffer is configured to buffer a fourth packet header information obtained when the RF receiver apparatus monitors the forwarding information, wherein the fourth packet header information is packet header information of the signal received by the RF receiver apparatus; and
the second information processing unit is configured to perform a correlation operation on the third packet header information and the fourth packet header information to obtain a forwarding correlation result, and determine, when the forwarding correlation result is greater than a second threshold, that Link 2 is the link on which information is monitored.

Optionally, the second information processing unit includes:
a second buffer, storing the third packet header information; and
a second correlation subunit, having an input end connected to an output end of the second buffer and an output end of the common buffer, wherein
the second correlation subunit is configured to perform the correlation operation on the third packet header information and the fourth packet header information to obtain the forwarding correlation result, and determine, when the forwarding correlation result is greater than the second threshold, that Link 2 is the link on which information is monitored.

Optionally, the packet header information of the audio source device includes a front part and a rear part, with the rear part lagging behind the front part in time sequence; and
the second buffer is configured to store the rear part, and the common buffer is configured to buffer data information corresponding to the length of the rear part.

Optionally, when information is monitored on both Link 1 and Link 2, the RF receiver apparatus receives, on Link 1 in a preset frequency band, the current audio data retransmitted by the audio source device, and simultaneously receives, on Link 2 in the same preset frequency band, the current audio data forwarded by the first audio playback device.

In a seventh aspect, an embodiment of the present invention discloses an audio playback device, including:
a processor, configured to implement the method disclosed in the first aspect above; and/or configured to implement the method disclosed in the second aspect above.

In an eighth aspect, an embodiment of the present invention discloses an audio playback device, including:
the circuit disclosed in the fifth aspect above; and/or the circuit disclosed in the sixth aspect above.

In a ninth aspect, an embodiment of the present invention discloses an audio signal processing system, including: a first audio playback device and a second audio playback device; wherein the first audio playback device and the second audio playback device are an audio playback device pair; wherein
the first audio playback device includes the apparatus disclosed in the third or fourth aspect above; and the second audio playback device includes the apparatus disclosed in the third or fourth aspect above; or
the first audio playback device includes the circuit disclosed in the fifth or sixth aspect above; and the second audio playback device includes the circuit disclosed in the fifth or sixth aspect above.

Optionally, the audio signal processing system further includes:
an audio source device, configured to provide audio data to the first audio playback device and the second audio playback device.

In a tenth aspect, an embodiment of the present invention discloses a computer-readable storage medium, storing a computer program, wherein the computer program stored in the storage medium is executed to implement the method disclosed in the first or second aspect above.

In a eleventh aspect, an embodiment of the present invention discloses a chip for an audio device, including an integrated circuit thereon, wherein the integrated circuit is designed to implement the method disclosed in the first or second aspect above, or is integrated with the circuit disclosed in the fifth or sixth aspect above.

### Beneficial Effects

According to a method, circuit, audio playback device, and system of sending and receiving Bluetooth packet loss data, a disclosed in the embodiments of the present invention, a forwarding request sent by a second audio playback device is received in a receiving state; retransmission information of an audio source device retransmitting a current audio data packet is monitored on Link 1 according to the forwarding request; switching from the receiving state to a sending state is performed when the retransmission information is monitored; the current audio data is forwarded to the second audio playback device via Link 2 in a time sequence of the audio source device retransmitting the current audio data, wherein Link 2 is an interactive link between a first audio playback device and the second audio playback device. That is, in a process of the audio source device retransmitting the current audio data via Link 1, the first audio playback device may synchronously forward the current audio data via Link 2. Link 1 and Link 2 are in different spatial locations. Therefore, the signal can be provided to the second audio playback device from different positions. That is, in the case of packet loss error correction, the second audio playback device can obtain a better spatial diversity gain, so the data receiving method is improved and the data error correction rate is increased in the presence of deep fading signals caused by the human body.

According to a method, circuit, audio playback device, and system of sending and receiving Bluetooth packet loss data disclosed in the embodiments of the present invention, when a second audio playback device fails to receive the current audio data sent by an audio source device, a first audio playback device and the audio source device are prompted that the second audio playback device does not successfully receive the current audio data; retransmission information of the audio source device retransmitting the current audio data t is monitored on Link 1; forwarding information of the first audio playback device forwarding the current audio data is monitored on Link 2; Link 1 and/or Link 2 is selected as a target link according to a retransmission determination result and a forwarding determination result to receive the current audio data, to perform error correction on the current packet loss data. That is, in a process of monitoring the current audio data retransmitted on Link 1, the current audio data forwarded on Link 2 is monitored synchronously. Link 1 and Link 2 are in different spatial locations, so the second audio playback device is subject to different interference by the human body, and the signal fading is different. Therefore, the current audio data can be obtained from different positions, and the link on which information is monitored is selected as a target link to receive the current audio data, so the way of the second audio playback device receiving the current audio data may be optimized. The data receiving method is improved, and the data error correction rate is increased in the presence of deep fading signals caused by the human body.

According to a method, circuit, audio playback device, and system of sending and receiving Bluetooth packet loss data disclosed in the embodiments of the present invention, an information operation module is configured to store a first packet header information locally, wherein the first packet header information is the packet header information of an audio source device; an RF receiver apparatus is configured to monitor, through the Bluetooth antenna, retransmission information of the audio source device retransmitting an audio data packet to obtain a second packet header information, wherein the second packet header information is the packet header information of the signal received by the RF receiver apparatus; the information operation module is configured to perform a correlation operation on the first packet header information and the second packet header information to obtain a correlation result, and output a forwarding drive signal to a transmitter module when the correlation result is greater than a preset value; the transmitter module is configured to forward, based on the forwarding drive signal outputted by the information operation module, the current audio data to a second audio playback device in the time sequence of the audio source device retransmitting the current audio data. That is, the information operation module performs the correlation operation on the signal monitored by the RF receiver apparatus. When the correlation result is greater than the preset value, it indicates that the audio data packet being retransmitted by the audio source device is monitored, and then the forwarding drive signal is outputted to the transmitter module, so that the transmitter module forwards the current audio data to the second audio playback device in the time sequence of the audio source device retransmitting the current audio data. That is, the first audio playback device and the audio source device forward the current audio data to the second audio playback device synchronously. Since the first audio playback device and the audio source device are in different spatial locations, a signal can be provided to the second audio playback device from different positions. That is, in the case of packet loss error correction, the second audio playback device can obtain a better spatial diversity gain. The data receiving method is improved and the data error correction rate is increased in the presence of deep fading signals caused by the human body.

According to a method, circuit, audio playback device, and system of sending and receiving Bluetooth packet loss data disclosed in the embodiments of the present invention, an RF receiver apparatus, a common buffer, and an information processing module are connected sequentially; when a second audio playback device fails to receive a current audio data packet, the RF receiver apparatus monitors, on Link 1, retransmission information of an audio source device retransmitting the current audio data packet, and monitors, on Link 2, forwarding information of a first audio playback device forwarding the current audio data; the common buffer is configured to buffer data of Link 1 and data of Link 2; the information processing module is configured to calculate data correlations based on the data of Link 1 and the data of Link 2 respectively and output a link selection control signal; the RF receiver apparatus is configured to select, according to the link selection control signal, a link on which information is monitored as a target link to receive the current audio data. That is, the audio source device and the first audio playback device send the current audio data simultaneously. The audio source device and the first audio playback device are in different spatial locations, so the second audio playback device is subject to different interference by the human body and the signal fading is different. Therefore, the current audio data can be obtained from different locations. In a process of monitoring the current audio data retransmitted by Link 1, the information processing module synchronously monitors the current audio data forwarded by Link 2, and calculates the data correlations based on the data of Link 1 and the data of Link 2 respectively, and determines the link on which the information is monitored to receive the current audio data. The way of the second audio playback device receiving the current audio data may be optimized. The data receiving method is improved and the data error correction rate is increased in the presence of deep fading signals caused by the human body.

Other beneficial effects of the present invention will be described in the specific embodiments by the presentation of specific technical features and technical solutions. A person skilled in the art should be able to understand, the beneficial technical effects brought by the technical features and technical solutions through the presentation of these technical features and technical solutions.

### BRIEF DESCRIPTION OF THE DRAWINGS

Exemplary embodiments of the present invention are described below with reference to the accompanying drawings. In the drawings:

FIG. 1 is a schematic diagram of an example of a communication structure of a dual wireless network in the related art;

FIG. 2 is a flowchart of a method of sending Bluetooth packet loss data according to an embodiment of the present invention;

FIG. 3 is a schematic diagram of an example of a user listening to audio signals from an audio source device according to an embodiment of the present invention;

FIG. 4 is a flowchart of a method for determining whether retransmission information is monitored according to an embodiment of the present invention;

FIG. 5A, FIG. 5B, and FIG. 5C are schematic diagrams of Bluetooth packet formats in a Bluetooth standard protocol, wherein FIG. 5A is a schematic diagram of a BDR packet format in Bluetooth v2.1, FIG. 5B is a schematic diagram of an EDR packet format in Bluetooth v2.1, and FIG. 5C is a schematic diagram of a packet format in Bluetooth Low Energy;

FIG. 6 is a flowchart of a method of receiving Bluetooth packet loss data according to an embodiment of the present invention;

FIG. 7 is a flowchart of a method for determining whether retransmission information is monitored to obtain a retransmission determination result according to an embodiment of the present invention;

FIG. 8 is a flowchart of a method for determining whether forwarding information is monitored to obtain a forwarding determination result according to an embodiment of the present invention;

FIG. 9 is a schematic structural diagram of a Bluetooth packet loss data sending apparatus according to an embodiment of the present invention;

FIG. 10 is a schematic structural diagram of a Bluetooth packet loss data receiving apparatus according to an embodiment of the present invention;

FIG. 11 is a schematic structural diagram of a Bluetooth communication transmitter circuit according to an embodiment of the present invention; and

FIG. 12 is a schematic structural diagram of a Bluetooth communication receiver circuit according to an embodiment of the present invention.

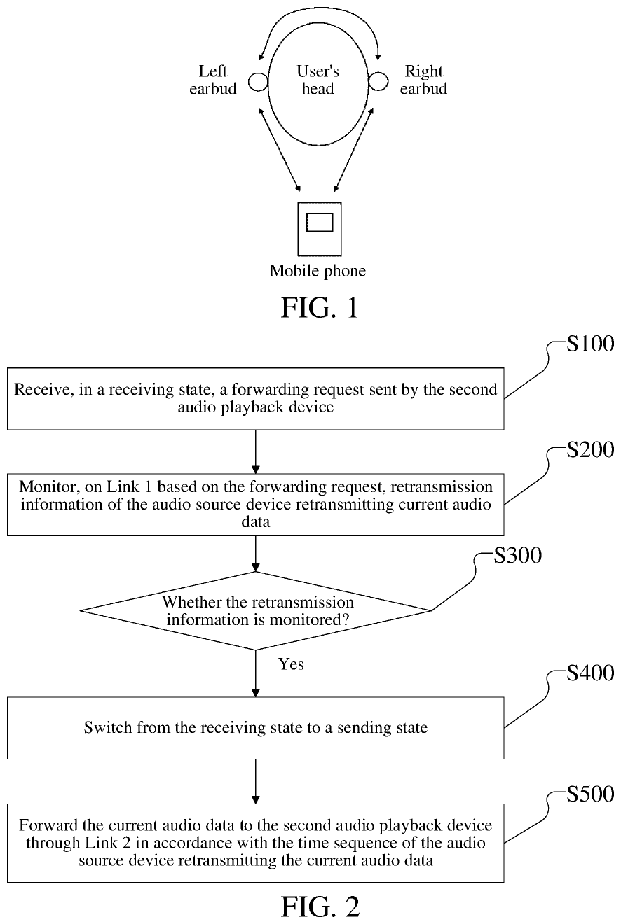

### DETAILED DESCRIPTION

The following description is of preferred embodiments by way of example only and without limitation to the combination of features necessary for carrying the invention into effect. In the following description, well-known functions or constructions are not described in detail since they may obscure the invention in unnecessary detail.

In addition, a person of ordinary skill in the art should understand that the accompanying drawings provided herein are for illustration purpose only and are not necessarily drawn to scale.

In the entire specification and claims, except where the context requires otherwise due to express language or necessary implication, the words “comprise” or “include” or variations such as “comprises”, “comprising”, “includes” or “including” is used in an inclusive sense, i.e., to specify the presence of the stated features but not to preclude the presence or addition of further features in various embodiments of the invention.

In the description of this application, it should be understood that the terms “first”, “second” and the like are used for the purpose of description only and are not to be construed as indicating or implying any priority or order of the element with respect to another element. In addition, in the description of this application, unless otherwise stated, “a plurality of” means two or more than two.

To improve the data receiving method and increase the data error correction rate in the presence of a deep fading signal caused by the human body, an embodiment of the present invention discloses a method of sending Bluetooth packet loss data. FIG. 2 is a flowchart of a method of sending Bluetooth packet loss data according to an embodiment of the present invention. The method of sending Bluetooth packet loss data is applied to a first audio playback device, wherein the first audio playback device and a second audio playback device form an audio playback device pair, and the first audio playback device and the second audio playback device are configured to separately receive audio data from an audio source device. In a specific embodiment, the first audio playback device and the second audio playback device form an audio playback device pair, such as left and right earbuds, or left and right channel speakers, etc. The first audio playback device, the second audio playback device, and the audio source device form a dual wireless communication Bluetooth network. In an embodiment, the first audio playback device and the second audio playback device receive the audio data sent by the audio source device by using a receiving/monitoring mode. In another embodiment, the first audio playback device and the second audio playback device separately receive audio data sent by the audio source device. In this embodiment, data exchange may be further performed between the first audio playback device and the second audio playback device.

Referring to FIG. 2, the method of sending Bluetooth packet loss data disclosed in this embodiment includes step S100, step S200, step S300, step S400, and step S500.

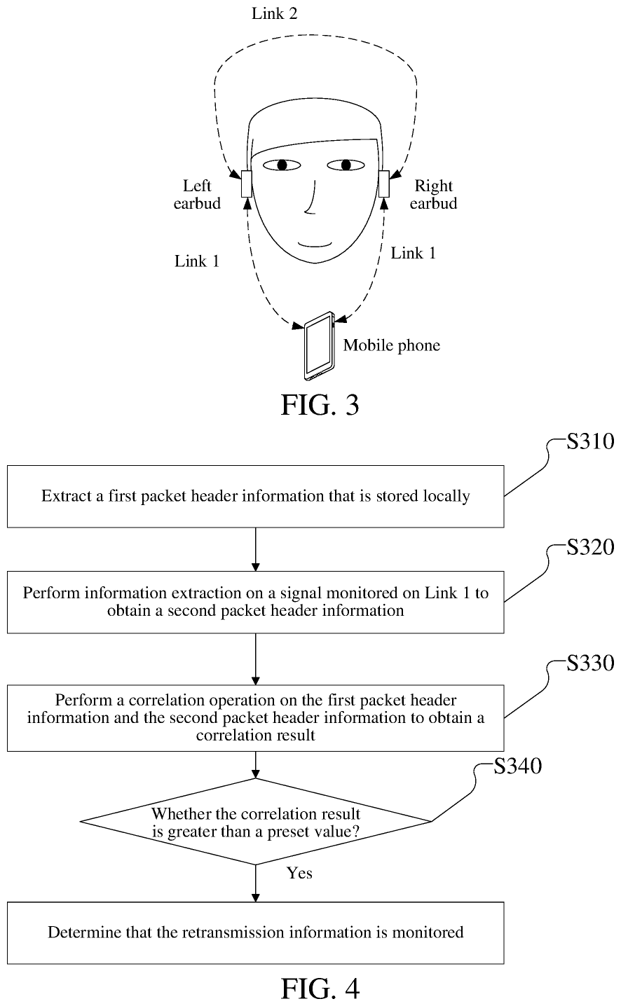

In Step S100, receive, in a receiving state, a forwarding request from the second audio playback device. In this embodiment, the so-called forwarding request indicates that the second audio playback device fails to receive the current audio data sent by the audio source device. FIG. 3 is a schematic diagram of an example of a user listening to audio signals from an audio source device according to an embodiment of the present invention. A left earbud and a right earbud correspond to the first audio playback device and the second audio playback device, and a mobile phone corresponds to the audio source device. In specific implementation, the left earbud and the right earbud both include transceiver antennas, the left earbud and the right earbud interact with the mobile phone via Link 1 for data interaction (e.g. receiving or monitoring the data sent by the mobile phone), and the left earbud interacts with the right earbud via Link 2. In this embodiment, the mobile phone sends data to the left earbud and the right earbud according to a standard protocol. When the right earbud fails to receive or monitor the current audio data sent by the mobile phone, the right earbud will send a prompt message indicating that the current audio data was not successfully received to the left earbud via Link 2.

In a specific implementation, according to the standard protocol, when the second audio playback device fails to receive the current audio data sent by the audio source device, a Negative Acknowledgment (NACK) indicating that the current audio data was not successfully received is sent to the audio source device via the first audio playback device or the second audio playback device, and the audio source device then retransmits the current audio data based on the NACK. In one embodiment, when the first audio playback device and the second audio playback device receive audio data from the audio source device by using the receiving/monitoring mode, the NACK may be sent to the audio source device through the receiver device. For example, when the first audio playback device receives the audio data, and the second audio playback device monitors the audio data, the NACK may be sent to the audio source device through the first audio playback device. Further, when the second audio playback device receives the audio data, and the first audio playback device monitors the audio data, the NACK may be sent to the audio source device through the second audio playback device. In another embodiment, when the first audio playback device and the second audio playback device receive the audio data from the audio source device by using a dual transmission mode, the NACK may be sent to the audio source device through the second audio playback device e, or the NACK may be sent to the audio source device through the first audio playback device in place of the second audio playback device when an anchor of the second audio playback device arrives.

It should be noted that, this embodiment does not limit the communication mode between the first audio playback device, the second audio playback device, and the audio source device, as long as the audio source device can be informed that the current audio data was not successfully received.

In Step S200, monitor, on Link 1 according to the forwarding request, retransmission information of the audio source device retransmitting the current audio data packet. In this embodiment, Link 1 is a link for the audio source device to send the audio data. In specific implementation, according to the standard protocol, when the second audio playback device fails to receive the current audio data sent by the audio source device, the audio source device retransmits the current audio data based on a Negative Acknowledgment (NACK), so that the second audio playback device performs error correction on the unsuccessfully received data according to the retransmitted current audio data. In this embodiment, because the audio source device retransmits the current audio data packet on Link 1, the retransmission information of the audio source device retransmitting the current audio data packet may be monitored on Link 1.

It should be noted that, since both the first audio playback device and the second audio playback device are connected to the audio source device, the first audio playback device can obtain the relevant link information of Link 1, and details are not described herein again.

In Step S300, determine whether the retransmission information is monitored. The first audio playback device may capture a radio signal in the air through a radio antenna, and specifically may monitor the signal of a corresponding frequency band. In a specific embodiment, whether a captured radio signal is from the audio source device may be determined by analyzing the monitored signal of the corresponding frequency band of Link 1. If the captured radio signal is sent from the audio source device, it may be considered that retransmission information is monitored, that is, the audio source device is retransmitting the current audio data packet. In this embodiment, if the retransmission information is monitored, step S400 and step S500 are performed sequentially.

In Step S400, switch from the receiving state to a sending state. In specific implementation, the sending and receiving of Bluetooth signals may be implemented by using an existing antenna and impedance circuit etc. In this embodiment, after the retransmission information from the audio source device is monitored, the antenna and the related circuit may be configured to be in the sending state, to facilitate data transmission.

In Step S500, forward the current audio data to the second audio playback device via Link 2 in the time sequence of the voice source device retransmitting the current audio data. In this embodiment, Link 2 is an interactive link between the first audio playback device and the second audio playback device. In this embodiment, the first audio playback device forwards the current audio data in the same time sequence as that of the audio source device, so that the second audio playback device can simultaneously receive the current audio data retransmitted by the audio source device and the current audio data forwarded by the first audio playback device. Therefore, the second audio playback device can obtain a better spatial diversity gain.

It should be noted that, “the same time sequence” mentioned in this embodiment may chronologically mean specific leading or lagging in time points, rather than completely equal time points.

In order that the second audio playback device can simultaneously receive data from both the audio source device and the first audio playback device, in an optional embodiment, in step S500, the same preset frequency band as that of the audio source device is used to forward the current audio data. The said preset frequency band may be determined empirically. Specifically, some frequency points in the preset frequency band can be used to receive the current data forwarded by the first audio playback device, and some other frequency points in the preset frequency band can be used to receive the current audio data retransmitted by the audio source device.

It should be noted that, in wireless communication, since the transceiver antenna may work in a frequency band composed of multiple frequency points in the same time period, based on this, in this embodiment, by allocating the frequency points in the preset frequency band, the data from the first audio playback device and the audio source device can be simultaneously received, and there is no need to add additional hardware, for example, no need to add additional antenna, etc.

It should be noted that, “simultaneously” mentioned in this embodiment may chronologically mean specific leading or lagging in time points, rather than completely equal time points.

In an optional embodiment, FIG. 4 is a flowchart of a method for determining whether retransmission information is monitored according to an embodiment of the present invention. When step S300 is performed, determining whether the retransmission information is monitored includes: step S310, step S320, step S330, and step S340.

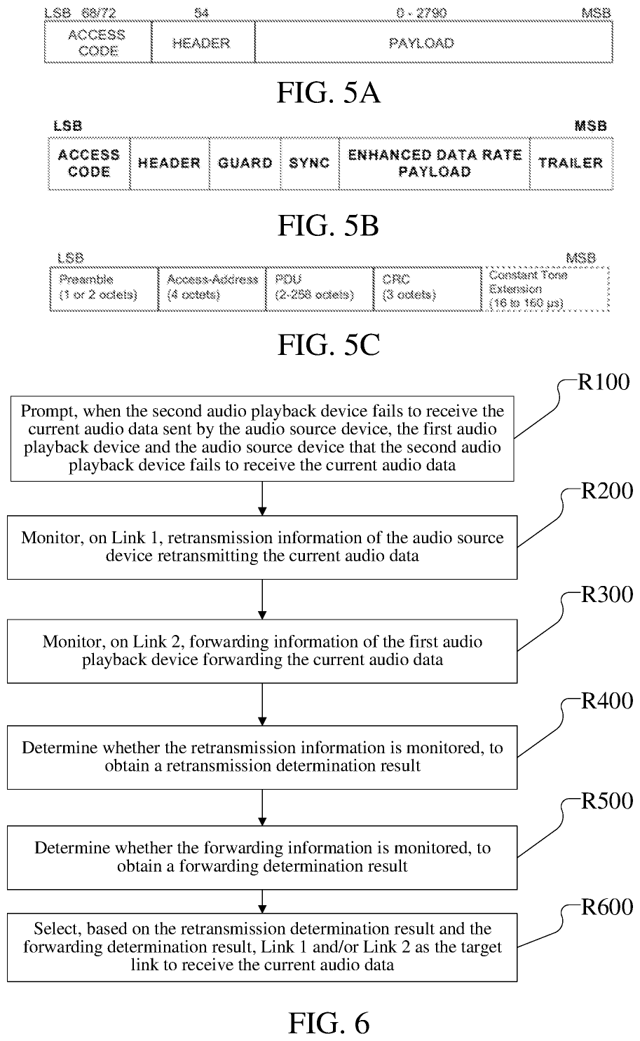

In Step S310, extract a first packet header information that is stored locally. In this embodiment, the first packet header information is the packet header information of the audio source device. Please refer to FIG. 5A, FIG. 5B, and FIG. 5C, which are schematic diagrams of Bluetooth packet formats in a Bluetooth standard protocol, where FIG. 5A is a schematic diagram of a BDR packet format in Bluetooth v2.1, FIG. 5B is a schematic diagram of an EDR packet format in Bluetooth v2.1, and FIG. 5C is a schematic diagram of a packet format in Bluetooth Low Energy. Generally speaking, Access code or Access address is the packet header information for a Bluetooth receiver to perform synchronization, packet detection, and receiving alignment; and the subsequent Header, Payload, or PDU has data information. In this embodiment, the packet header information of the audio source device is Access code or Access address. In specific implementation, the packet header information of the audio source device, such as Access code or Access address, may be stored locally, and therefore the stored packet header information may be directly extracted.

In Step S320, perform information extraction on the signal monitored on Link 1 to obtain a second packet header information. In this embodiment, when a signal on Link 1 is monitored, information extraction may be performed on the monitored signal to obtain the second packet header information. With the second packet header information, the identity of the signal sender can be confirmed, for example, by packet detection.

In Step S330, perform a correlation operation on the first packet header information and the second packet header information to obtain a correlation result. In a specific embodiment, the correlation operation, such as convolution or matrix operation etc., can be performed to obtain the correlation result.

In Step S340, determine whether the correlation result is greater than a preset value. In this embodiment, the preset value may be determined empirically. In this embodiment, if the correlation result is greater than the preset value, it is determined that the retransmission information is monitored.

In order to better perform data synchronization and reduce the data computation, in an optional embodiment, the packet header information of the audio source device includes a front part and a rear part, with the rear part lagging behind the front part in time sequence. The first packet header information is the front part, and the second packet header information is the data information corresponding to the length of the front part. That is, the packet header information of the audio source device is divided into two parts in time sequence: the front part and the rear part, where, the front part is stored locally as the first packet header information. When the retransmission information is monitored, only the data information corresponding to the length of the front part needs to be extracted, and this part is used as the second packet header information to do the correlation operation with the first packet header information, so that the calculation amount of the correlation operation may be reduced.

In step S500, after switching to the sending state, the rear part and the current audio data are forwarded sequentially immediately, to keep in synchronization with the time sequence of the audio source device retransmitting the rear part and the current audio data. That is, after switching to the sending state, the rear part and the immediately following forwarding packet data body part are forwarded immediately. When the correlation operation is performing, the audio source device is retransmitting the rear part and the immediately following retransmission packet data body part. In this case, the rear part is sent immediately, so the timing can be kept synchronized with the retransmission of the audio source device retransmitting the rear part and the immediately following data body part.

In order to improve data receiving method and increase data error correction rate in the presence of deep fading signals caused by human body, an embodiment of the present invention discloses a method of receiving Bluetooth packet loss data. FIG. 6 is a flowchart of a method of receiving Bluetooth packet loss data according to an embodiment of the present invention. The method of receiving Bluetooth packet loss data is applied to a second audio playback device, where a first audio playback device and the second audio playback device form an audio playback device pair, and the first audio playback device and the second audio playback device are configured to separately receive audio data from an audio source device. In a specific embodiment, the first audio playback device and the second audio playback device form an audio playback device pair, such as left and right earbuds, or left and right channel speakers, etc. The first audio playback device, the second audio playback device, and the audio source device form a dual wireless communication Bluetooth network. In an embodiment, the first audio playback device and the second audio playback device receive audio data from the audio source device by using receiving/monitoring mode. In another embodiment, the first audio playback device and the second audio playback device separately receive audio data from the audio source device. In this embodiment, data exchange may be further performed between the first audio playback device and the second audio playback device.

Referring to FIG. 6, the method of receiving Bluetooth packet loss data disclosed in this embodiment includes step R100, step R200, step R300, step R400, and step R500.

In Step R100, prompt, when the second audio playback device fails to receive the current audio data sent by the audio source device, the first audio playback device and the audio source device that the second audio playback device has not successfully received the current audio data. FIG. 3 is a schematic diagram of an example of a user listening to audio signals from an audio source device according to an embodiment of the present invention. A left earbud and a right earbud correspond to the first audio playback device and the second audio playback device, and a mobile phone corresponds to the voice source device. In specific implementation, both the left earbud and the right earbud include transceiver antennas, and the left earbud and the right earbud interact with the mobile phone via Link 1 for data interaction (e.g. receiving or monitoring the data sent by the mobile phone), and the left earbud interacts with the right earbud via Link 2 for data interaction. In this embodiment, the mobile phone sends data to the left earbud and the right earbud according to a standard protocol, and when the right earbud fails to receive or monitor the current audio data sent by the mobile phone, the right earbud sends a prompt message to the left earbud via Link 2, indicating that the current audio data was not successfully received.

For prompting the audio source device (for example, the mobile phone) that the current audio data was not successfully received: in specific implementation, according to the standard protocol, when the second audio playback device fails to receive the current audio data sent by the audio source device, a Negative Acknowledgment (NACK) indicating that the current audio data was not successfully received is sent to the audio source device through the first audio playback device or the second audio playback device, and the audio source device then retransmits the current audio data based on the NACK. In one embodiment, when the first audio playback device and the second audio playback device receive audio data from the audio source device by using the receiving/monitoring mode, the NACK may be sent to the audio source device through a receiver device. For example, when the first audio playback device receives the audio data, and the second audio playback device monitors the audio data, the NACK may be sent to the audio source device through the first audio playback device. Further, when the second audio playback device receives audio data, and the first audio playback device monitors the audio data, the NACK may be sent to the audio source device through the second audio playback device. In another embodiment, when the first audio playback device and the second audio playback device receive the audio data from the audio source device in a dual transmission mode, the NACK may be sent to the audio source device through the second audio playback device, or the NACK may be sent to the audio source device through the first audio playback device in place of the second audio playback device when an anchor of the second audio playback device arrives.

It should be noted that, this embodiment does not limit the communication mode between the first audio playback device, the second audio playback device, and the audio source device, as long as the audio source device can be informed that the current audio data was not successfully received.

In Step R200, monitor, on Link 1, retransmission information of the audio source device retransmitting the current audio data packet. In this embodiment, Link 1 is a link for the audio source device to send the audio data. In this embodiment, when the audio source device obtains the NACK indicating that the second audio playback device failed to receive the current audio data, the audio source device retransmits the current audio data packet in a preset frequency band via Link 1. Therefore, the retransmission information of the audio source device may be monitored on Link 1. Specifically, a radio signal in the air can be captured through a radio antenna, and specifically the signal of a corresponding frequency band can be monitored. In a specific embodiment, whether a captured radio signal is from the audio source device may be determined by analyzing the monitored signal of the corresponding frequency band of Link 1, and if the radio signal is sent by the audio source device, it can be considered that the retransmission information is monitored, that is, the audio source device is retransmitting the current audio data packet.

In Step R300, monitor, on Link 2, forwarding information of the first audio playback device forwarding the current audio data. In this embodiment, Link 2 is an interactive link between the first audio playback device and the second audio playback device. In this embodiment, when the first audio playback device obtains the forwarding request sent by the second audio playback device, the first audio playback device forwards the current audio data packet via Link 2 in the same preset frequency band as that of the audio source device. Therefore, the forwarding information of the first audio playback device can be monitored on Link 2. Specifically, a radio signal in the air may be captured through a radio antenna, and specifically the signal of a corresponding frequency band can be monitored. In a specific embodiment, whether the captured radio signal is from the first audio playback device may be determined by analyzing the monitored signal of the frequency band of Link 2, and if the captured radio signal is sent by the first audio playback device, it can be considered that the forwarding information is monitored, that is, the first audio playback device is forwarding the current audio data packet.

In this embodiment, the first audio playback device forwards the current audio data by using the same preset frequency band as that of the audio source device. The preset frequency band may be determined empirically. Specifically, some frequency points in the preset frequency band can be used to receive the current data forwarded by the first audio playback device, and some other frequency points in the preset frequency band can be used to receive the current audio data retransmitted by the audio source device.

It should be noted that, in wireless communication, since the transceiver antenna may work in a frequency band composed of multiple frequency points in the same time period, based on this, in this embodiment, by allocating the frequency points in the preset frequency band, the data from the first audio playback device and the audio source device can be simultaneously received, and there is no need to add additional hardware, for example, no need to add additional antenna.

It should be noted that, “simultaneously” mentioned in this embodiment may chronologically mean specific leading or lagging in time points, rather than completely equal time points.

It should be noted that, in this embodiment, the sequence of step R200 and step R300 is not limited.

In Step R400, determine whether the retransmission information is monitored, to obtain a retransmission determination result. Specifically, the signal captured on Link 1 can be analyzed to determine whether the retransmission information is monitored, to obtain a retransmission determination result.

In Step R500, determine whether the forwarding information is monitored, to obtain a forwarding determination result. Specifically, the signal captured on Link 2 can be analyzed to determine whether the forwarding information is monitored, to obtain a forwarding determination result.

It should be noted that, in this embodiment, the sequence of step R400 and step R500 is not limited.

In Step R600, select, based on the retransmission determination result and the forwarding determination result, Link 1 and/or Link 2 as the target link(s) to receive the current audio data. In this embodiment, after the retransmission determination result and the forwarding determination result are obtained, one or two links may be selected to receive the current audio data, thereby performing error correction on the current packet loss data, wherein the link selected to receive the current audio data is the link where the information is monitored. Specifically, because the locations of the audio source device and the first audio playback device are different, the audio source device and the first audio playback device are subject to different human interference, that is, also have different signal strengths of communication with the second audio playback device. In this embodiment, through the retransmission determination result and the forwarding determination result, it may be determined whether the current audio data of the audio source device and the first audio playback device can be received.

In a specific implementation, when the retransmission determination result is that the retransmission information is monitored, Link 1 is selected as the target link to receive the current audio data, that is, within a preset receiving bandwidth range, the current audio data retransmitted by the audio source device is received through Link 1;
when the forwarding determination result is that the forwarding information is monitored, Link 2 is selected as the target link to receive the current audio data, that is, within the preset receiving bandwidth range, the current audio data forwarded by the first audio playback device is received through Link 2; or
when the retransmission determination result is that the retransmission information is monitored and the forwarding determination result is that the forwarding information is monitored, Link 1 and the Link 2 are selected as the target links to receive the current audio data, that is, within the preset receiving bandwidth range, the current audio data retransmitted by the audio source device and the current audio data forwarded by the first audio playback device are simultaneously received.

In an optional embodiment, the current audio data is received on the target link in the same preset frequency band. That is, the first audio playback device forwards the current audio data by using the same preset frequency band as that of the audio source device. The second audio playback device receives the current audio data of the audio source device and the current audio data of the first audio playback device simultaneously in the same preset frequency band.

The preset frequency band may be determined empirically. Specifically, some frequency points in the preset frequency band can be used to receive the current data forwarded by the first audio playback device, and some other frequency points in the preset frequency band can be used to receive the current audio data retransmitted by the audio source device.

It should be noted that, in wireless communication, since the transmit and receive antenna may work in a frequency band composed of multiple frequency points in the same time period, based on this, in this embodiment, by allocating frequency points in the preset frequency band, the data of the first audio playback device and the audio source device can be simultaneously received, and there is no need to add additional hardware device, for example, no need to add additional antenna, etc.

It should be noted that, “simultaneously” mentioned in this embodiment may chronologically mean specific leading or lagging in time points, rather than completely equal time points.

In this embodiment, Link 1 and Link 2 is used as the target links to receive the current audio data, and Link 1 and Link 2 are in different spatial locations. Therefore, the signal can be provided to the second audio playback device from different locations. That is, in the case of packet loss error correction, the second audio playback device can obtain a better spatial diversity gain. the data receiving method is improved and the data error correction rate is increased in the presence of deep fading signals caused by the human body.

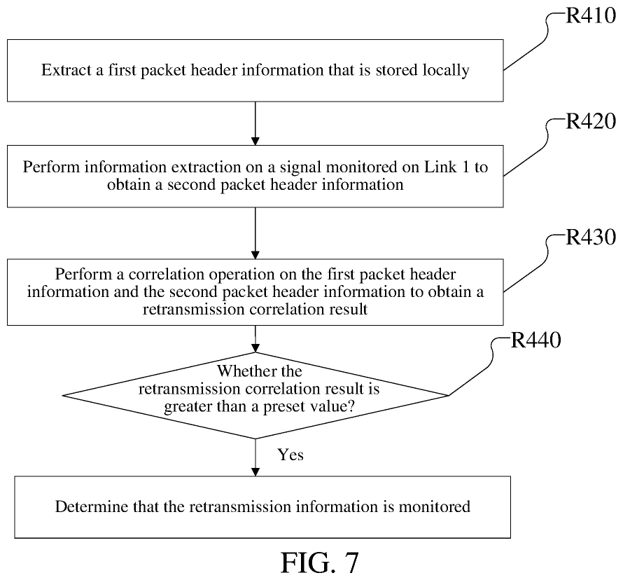

In an optional embodiment, FIG. 7 is a flowchart of a method for determining whether retransmission information is monitored to obtain a retransmission determination result according to an embodiment of the present invention. When step R400 is performed, determining whether retransmission information is monitored to obtain a retransmission determination result includes: step R410, step R420, step R430, and step R440.

In Step R410, extract a first packet header information that is stored locally. In this embodiment, the first packet header information is the packet header information of the audio source device. Please refer to FIG. 5A, FIG. 5B, and FIG. 5C, which are schematic diagrams of Bluetooth packet formats in a Bluetooth standard protocol, where FIG. 5A is a schematic diagram of a BDR packet format in Bluetooth v2.1, FIG. 5B is a schematic diagram of an EDR packet format in Bluetooth v2.1, and FIG. 5C is a schematic diagram of a packet format in Bluetooth Low Energy. Generally speaking, Access code or Access address is the packet header information for a Bluetooth receiver to perform synchronization, packet detection, and receiving alignment; and the subsequent Header, Payload, or PDU has data information. In this embodiment, the packet header information of the audio source device is Access code or Access address. In specific implementation, the packet header information of the audio source device, such as Access code or Access address, can be stored locally, and therefore the stored packet header information can be directly extracted.

In Step R420, perform information extraction on the signal monitored on Link 1 to obtain a second packet header information. In this embodiment, when a signal on Link 1 is monitored, information extraction may be performed on the monitored signal to obtain the second packet header information. With the second packet header information, the identity of the signal sender can be confirmed, for example, by packet detection.

In Step R430, perform a correlation operation on the first packet header information and the second packet header information to obtain a retransmission correlation result. In a specific embodiment, the correlation operation such as convolution or matrix operation, may be performed to obtain a correlation result.

In Step R440, determine whether the retransmission correlation result is greater than a preset value. In this embodiment, the preset value may be determined empirically. In this embodiment, if the retransmission correlation result is greater than the preset value, it is determined that the retransmission information is monitored.

In one embodiment, in order to reduce the amount of data operation, in an optional embodiment, the packet header information of the audio source device includes a front part and a rear part, with the rear part lagging behind the front part in time sequence. The first packet header information is the front part, and the second packet header information is the data information corresponding to the length of the front part. That is, the packet header information of the audio source device is divided into two parts in time sequence: the front part and the rear part, wherein the front part is stored locally as the first packet header information. When the retransmission information is monitored, only the data information corresponding to the length of the front part needs to be extracted, and this part is used as the second packet header information to do the correlation operation with the first packet header information, so that the calculation amount of the correlation operation may be reduced.

In another embodiment, considering the possibility of signal loss, in order to improve the integrity of the correlation operation, in an optional embodiment, the first packet header information is the complete packet header information of the audio source device, and the second packet header information is at least a part of the complete packet header information. That is, when partial information is monitored on Link 1, a correlation operation can be performed on the partial information and the data in the corresponding part of the first packet header information, to obtain a retransmission correlation result. Therefore, misunderstanding that no retransmission information is monitored due to signal interference can be avoided.

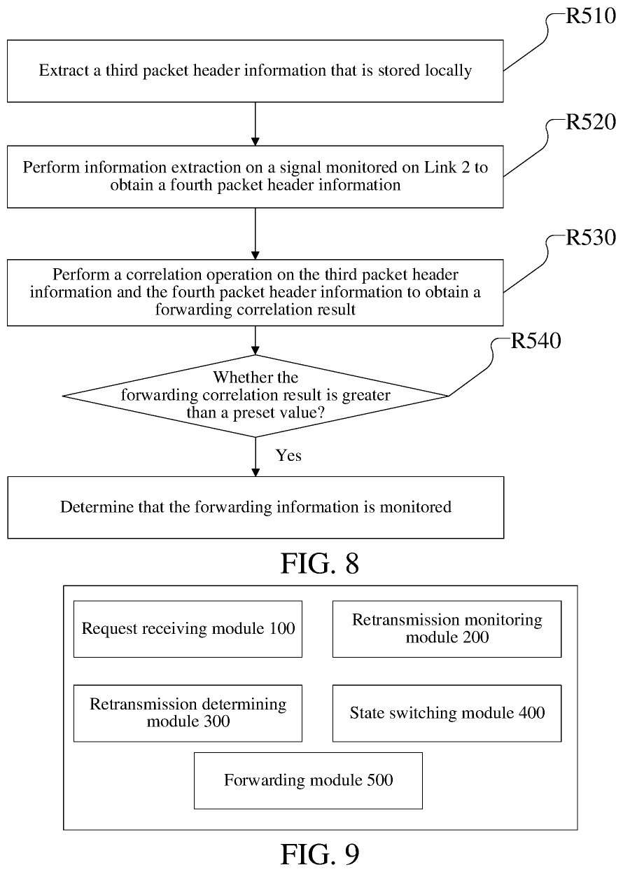

In an optional embodiment, FIG. 8 is a flowchart of a method for determining whether forwarding information is monitored to obtain a forwarding determination result according to an embodiment of the present invention. When step R500 is performed, determining whether forwarding information is monitored to obtain a forwarding determination result includes: step R510, step R520, step R530, and step R540.

In Step R510, extract a third packet header information that is stored locally. In this embodiment, the third packet header information is the packet header information of the audio source device. Please refer to FIG. 5A, FIG. 5B, and FIG. 5C, which are schematic diagrams of Bluetooth packet formats in a Bluetooth standard protocol, where FIG. 5A is a schematic diagram of a BDR packet format in Bluetooth v2.1, FIG. 5B is a schematic diagram of an EDR packet format in Bluetooth v2.1, and FIG. 5C is a schematic diagram of a packet format in Bluetooth Low Energy. Generally speaking, Access code or Access address is the packet header information for a Bluetooth receiver to perform synchronization, packet detection, and receiving alignment, and the subsequent Header, Payload, or PDU has data information. In this embodiment, the packet header information of the audio source device is Access code or Access address. In specific implementation, the packet header information of the audio source device, such as Access code or Access address, can be stored locally, and therefore the stored packet header information may be directly extracted.

It should be noted that, although the data packet is forwarded by the first audio playback device, it contains the packet header information of the audio source device because the data packet forwarded by the first audio playback device is the current audio data packet. Therefore, the third packet header information is the packet header information of the audio source device.

In Step R520, perform information extraction on the signal monitored on Link 2 to obtain a fourth packet header information. In this embodiment, when a signal on Link 2 is monitored, information extraction may be performed on the monitored signal to obtain the fourth packet header information. With the fourth packet header information, the identity of the signal sender can be confirmed, for example, by packet detection.

In Step R530, perform a correlation operation on the third packet header information and the fourth packet header information to obtain a forwarding correlation result. In a specific embodiment, the correlation operation such as convolution or matrix operation, can be performed to obtain the forwarding correlation result.

In Step R540, determine whether the forwarding correlation result is greater than a preset value. In this embodiment, the preset value may be determined empirically. In this embodiment, if the forwarding correlation result is greater than the preset value, it is determined that the forwarding information is monitored.

In order to better synchronize data and reduce the amount of data operation, in an optional embodiment, the packet header information of the audio source device includes a front part and a rear segment part, with the rear part lagging behind the front part in time sequence. The third packet header information is the rear part, and the fourth packet header information is the data information corresponding to the length of the rear part. That is, the packet header information of the audio source device is divided into two parts in time sequence: a front part and a rear part, wherein the rear part is stored locally as the third packet header information. When the forwarding information is monitored, only the data information corresponding to the length of the rear part needs to be extracted, and this part is used as the fourth packet header information to do the correlation operation with the third packet header information, so that the calculation amount of the correlation operation may be reduced.

It should be noted that, in this embodiment, since the first audio playback device forwards only the rear part and an immediately following retransmission packet data body part when forwarding audio data, only the rear part needs to be stored locally as the third packet header information.

The present invention further discloses a Bluetooth packet loss data sending apparatus. FIG. 9 is a schematic structural diagram of a Bluetooth packet loss data sending apparatus according to an embodiment of the present invention. The Bluetooth packet loss data sending apparatus is applied to a first audio playback device. The first audio playback device and a second audio playback device form an audio playback device pair, and the first audio playback device and the second audio playback device are configured to receive audio data from an audio source device respectively. The apparatus includes: a request receiving module 100, a retransmission monitoring module 200, a retransmission determining module 300, a state switching module 400, and a forwarding module 500.

The request receiving module 100 is configured to receive, in a receiving state, a forwarding request sent by the second audio playback device, wherein the forwarding request indicates that the second audio playback device fails to receive the current audio data sent by the audio source device.

The retransmission monitoring module 200 is configured to monitor, on Link 1 according to the forwarding request, retransmission information of the audio source device retransmitting the current audio data packet, wherein Link 1 is the link for the audio source device to send the audio data.

The retransmission determining module 300 is configured to determine whether the retransmission information is monitored. If the retransmission information is monitored, the state switching module 400 and the forwarding module 500 are operated sequentially.

The state switching module 400 is configured to switch from the receiving state to a sending state.

The forwarding module 500 is configured to forward the current audio data to the second audio playback device via Link 2 in the time sequence of the audio source device retransmitting the current audio data, wherein the link 2 is an interactive link between the first audio playback device and the second audio playback device.

In an optional embodiment, the forwarding module 500 is configured to forward the current audio data by using the same preset frequency band as that of the audio source device.

In an optional embodiment, the retransmission determining module 300 includes:
a first extraction unit, configured to extract first packet header information stored locally, wherein the first packet header information is the packet header information of the audio source device;
a second extraction unit, configured to extract information from the signal monitored on Link 1 to obtain second packet header information;
a correlation operation unit, configured to perform a correlation operation on the first packet header information and the second packet header information to obtain a correlation result; and
a preset value determining unit, configured to determine whether the correlation result is greater than a preset value, and determine, if the correlation result is greater than the preset value, that the retransmission information is monitored.

In an optional embodiment, the packet header information of the audio source device includes a front part and a rear part, with the rear part lagging behind the front part in time sequence. The first packet header information is the front part, and the second packet header information is the data information corresponding to the length of the front part.

In an optional embodiment, the forwarding module 500 is configured to forward, after switching to the sending state, the rear part and the current audio data sequentially immediately, to keep in synchronization with the time sequence of the audio source device retransmitting the rear part and the current audio data.

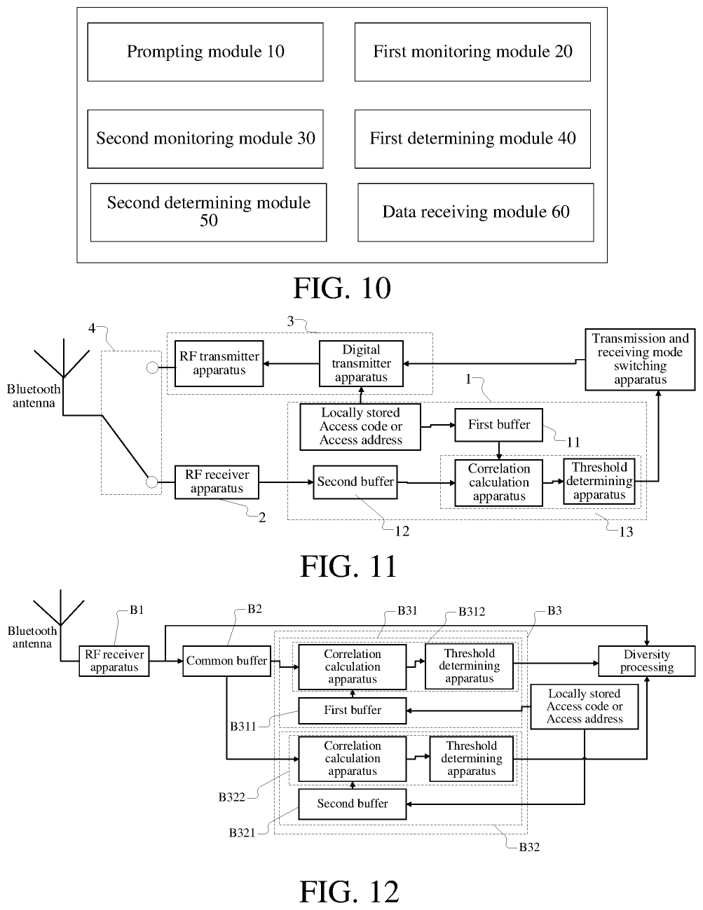

The present invention further discloses a Bluetooth packet loss data receiving apparatus. FIG. 10 is a schematic structural diagram of a Bluetooth packet loss data receiving apparatus according to an embodiment of the present invention. The Bluetooth packet loss data receiving apparatus is applied to a second audio playback device. A first audio playback device and the second audio playback device form an audio playback device pair, and the first audio playback device and the second audio playback device are configured to receive audio data from an audio source device respectively. The apparatus includes: a prompting module 10, a first monitoring module 20, a second monitoring module 30, a first determining module 40, a second determining module 50, and a data receiving module 60.

The prompting module 10 is configured to prompt, when the second audio playback device fails to receive the current audio data sent by the audio source device, the first audio playback device and the audio source device that the second audio playback device has not successfully received the current audio data.

The first monitoring module 20 is configured to monitor, on Link 1, retransmission information of the audio source device retransmitting the current audio data packet, wherein Link 1 is the link for the audio source device to send audio data.

The second monitoring module 30 is configured to monitor, on Link 2, forwarding information of the first audio playback device forwarding the current audio data, wherein Link 2 is the interactive link between the first audio playback device and the second audio playback device.

The first determining module 40 is configured to determine whether the retransmission information is monitored, to obtain a retransmission determination result.

The second determining module 50 is configured to determine whether the forwarding information is monitored, to obtain a forwarding determination result.

The data receiving module 60 is configured to select, according to the retransmission determination result and the forwarding determination result, Link 1 and/or Link 2 as the target link(s) to receive the current audio data, to perform error correction on the current packet loss data.

In an optional embodiment, the first determining module 40 includes:
a first extraction unit, configured to extract first packet header information that is stored locally, wherein the first packet header information is the packet header information of the audio source device;
a second extraction unit, configured to extract information from the signal monitored on Link 1 to obtain second packet header information;
a retransmission correlation operation unit, configured to perform a correlation operation on the first packet header information and the second packet header information to obtain a retransmission correlation result; and
a first determining unit, configured to determine whether the retransmission correlation result is greater than a preset value, and determine, if the retransmission correlation result is greater than the preset value, that the retransmission information is monitored.

In an optional embodiment, the packet header information of the audio source device includes a front part and a rear part, with the rear part lagging behind the front part in time sequence. The first packet header information is the front part, and the second packet header information is the data information corresponding to the length of the front part.

In an optional embodiment, the first packet header information is the complete packet header information of the audio source device, and the second packet header information is at least a part of the complete packet header information.

In an optional embodiment, the second determining module 50 includes:
a third extraction unit, configured to extract third packet header information that is stored locally, where the third packet header information is the packet header information of the audio source device;
a fourth extraction unit, configured to extract information from the signal monitored on Link 2 to obtain fourth packet header information;
a forwarding correlation operation unit, configured to perform a correlation operation on the third packet header information and the fourth packet header information to obtain a forwarding correlation result; and
a second determining unit, configured to determine whether the forwarding correlation result is greater than a preset value, and determine, if the forwarding correlation result is greater than the preset value, that the forwarding information is monitored.

In an optional embodiment, the packet header information of the audio source device includes a front part and a rear part, with the rear part lagging behind the front part in time sequence. The third packet header information is the rear part, and the fourth packet header information is the data information corresponding to the length of the rear part.

In an optional embodiment, the data receiving module 60 is configured to:
select, when the retransmission determination result is that the retransmission information is monitored, Link 1 as a target link to receive the current audio data; or
select, when the forwarding determination result is that the forwarding information is monitored, Link 2 as a target link to receive the current audio data; or
select, when the retransmission determination result is that the retransmission information is monitored and the forwarding determination result is that the forwarding information is monitored, Link 1 and Link 2 as target links to receive the current audio data.

In an optional embodiment, the current audio data is received on the target link in the same preset frequency band.

In order to improve data receiving method and increase data error correction rate in the presence of deep fading signal caused by the human body, an embodiment of the present invention discloses a Bluetooth communication transmitter circuit. FIG. 11 is a schematic structural diagram of a Bluetooth communication transmitter circuit according to an embodiment of the present invention. The Bluetooth communication transmitter circuit is applied to a first audio playback device. The first audio playback device and a second audio playback device form an audio playback device pair, and the first audio playback device and the second audio playback device are configured to receive audio data from an audio source device respectively. In a specific embodiment, the first audio playback device and the second audio playback device form an audio playback device pair, for example, left and right earbuds or left and right channel speakers. The first audio playback device, the second audio playback device, and the audio source device form a dual wireless communication Bluetooth network. In an embodiment, the first audio playback device and the second audio playback device receive the audio data from the audio source device by using receiving/monitoring mode. In another embodiment, the first audio playback device and the second audio playback device separately receive audio data from the audio source device. In this embodiment, data exchange may be further performed between the first audio playback device and the second audio playback device.

Referring to FIG. 11, the Bluetooth communication transmitter circuit disclosed in this embodiment of the present invention includes: an information operation module 1, an RF receiver apparatus 2, and a transmitter module 3.

The information operation module 1 has a first packet header information stored locally. In this embodiment, the first packet header information is the packet header information of the audio source device. Please refer to FIG. 5A, FIG. 5B, and FIG. 5C, which are schematic diagrams of Bluetooth packet formats in a Bluetooth standard protocol, wherein FIG. 5A is a schematic diagram of a BDR packet format in Bluetooth v2.1, FIG. 5B is a schematic diagram of an EDR packet format in Bluetooth v2.1, and FIG. 5C is a schematic diagram of a packet format in Bluetooth Low Energy. Generally speaking, Access code or Access address is the packet header information for a Bluetooth receiver to perform synchronization, packet detection, and receiving alignment; and the subsequent Header, Payload, or PDU has data information. In this embodiment, the packet header information of the audio source device is Access code or Access address. In specific implementation, the packet header information of the audio source device, for example, Access code or Access address can be stored locally, and therefore the stored packet header information can be directly extracted.

An input end of the RF receiver apparatus 2 is connected to a Bluetooth antenna, and an output end of the RF receiver apparatus 2 is connected to the information operation module 1. In this embodiment, the RF receiver apparatus 2 is configured to obtain a second packet header information by monitoring the retransmission information of the audio source device retransmitting the audio data packet through the Bluetooth antenna. In this embodiment, the second packet header information is the packet header information of the signal received by the RF receiver apparatus 2. In a specific embodiment, when the RF receiver apparatus 2 monitors a signal of the audio source device through the Bluetooth antenna, information extraction may be performed on the monitored signal to obtain the second packet header information. With the second packet header information, the identity of the signal sender can be confirmed, for example, by packet detection.

In a specific implementation, the information operation module 1 is configured to perform a correlation operation on the first packet header information and the second packet header information to obtain a correlation result, and output a forwarding drive signal to the transmitter module 3 when the correlation result is greater than a preset value. In this embodiment, the preset value may be determined empirically. In this embodiment, if the correlation result is greater than the preset value, it can be determined that the retransmission information is monitored. In a specific embodiment, the correlation operation such as convolution or matrix operation, can be performed to obtain the correlation result.

The transmitter module 3 is connected to the information operation module 1, and the transmitter module 3 is configured to forward, based on the forwarding drive signal output from the information operation module 1, the current audio data to the second audio playback device in the time sequence of the audio source device retransmitting the current audio data. Referring to FIG. 11, the transmitter module 3 is implemented by including an RF transmitter apparatus and a digital transmitter apparatus. In this embodiment, when it is determined that the retransmission information is monitored, the transmitter module 3 forwards the current audio data in the same time sequence as that of the audio source device, so that the second audio playback device can simultaneously receive the current audio data retransmitted by the audio source device and the current audio data forwarded by the first audio playback device, therefore the second audio playback device can obtain better spatial diversity gain.

It should be noted that, “the same time sequence” mentioned in this embodiment may chronologically mean specific leading or lagging in time points, rather than completely equal time points.

In order to facilitate the second audio playback device to simultaneously receive data from the audio source device and the first audio playback device, in an optional embodiment, the transmitter module 3 is configured to forward the current audio data by using the same preset frequency band as that of the audio source device. The preset frequency band may be determined empirically. Specifically, the second audio playback device can use some frequency points in the preset frequency band to receive the current data forwarded by the first audio playback device, and use some other frequency points in the preset frequency band to receive the current audio data retransmitted by the audio source device.

It should be noted that, in wireless communication, because the transceiver antenna can work in a frequency band composed of multiple frequency points in the same time period, based on this, in this embodiment, by allocating the frequency points in the preset frequency band, the data from the first audio playback device and the audio source device can be simultaneously received, and there is no need to add additional hardware, for example, no need to add additional antenna.

It should be noted that, “simultaneously” mentioned in this embodiment may chronologically mean specific leading or lagging in time points, rather than completely equal time points.

Referring to FIG. 11, in an optional embodiment, the information operation module 1 includes: a first buffer 11, a second buffer 12, and a correlation unit 13.

The first buffer 11 is configured to store the first packet header information.

The second buffer 12 is connected to the output end of the RF receiver apparatus 2. In this embodiment, the second buffer 12 is configured to buffer the second packet header information.

An input end of the correlation unit 13 is connected to an output end of the first buffer 11 and an output end of the second buffer 12, and an output end of the correlation unit 13 is connected to the transmitter module 3. In this embodiment, the correlation unit 13 is configured to perform the correlation operation on the first packet header information and the second packet header information to obtain the correlation result, and output the forwarding drive signal to the transmitter module 3 when the correlation result is greater than the preset value. In specific implementation, the correlation unit 13 may be implemented by a correlation calculation apparatus and a threshold determining apparatus. Specifically, the correlation calculation apparatus may perform convolution, matrix operation, etc. This embodiment does not limit the specific calculation method of correlation calculation. The threshold determining apparatus may be implemented by, for example, a comparator circuit.

Referring to FIG. 11, in an optional embodiment, the Bluetooth communication transmitter circuit further includes a switch 4. One end of the switch 4 is connected to the Bluetooth antenna, and the other end selectively connected to the RF receiver apparatus 2 or the transmitter module 3. That is, the other end of the switch 4 is either connected to the RF receiver apparatus 2 or connected to the transmitter module 3. In specific implementation, when the other end of the switch 4 is connected to the RF receiver apparatus 2, the RF receiver apparatus 2 monitors the retransmission information through the Bluetooth antenna; and when the other end of the g switch 4 is connected to the transmitter module 3, the transmitter module 3 forwards the current audio data through the Bluetooth antenna.

In order to better perform data synchronization and reduce the amount of data operation, in an optional embodiment, the packet header information of the audio source device includes a front part and a rear part, with the rear part lagging behind the front part in time sequence. The first buffer 11 is configured to store the front part; the second buffer 12 is configured to buffer data information corresponding to the length of the front part in the second packet header information. That is, the packet header information of the audio source device is divided into two parts in time sequence: a front part and a rear part, wherein the front part is stored locally as the first packet header information. When the RF receiver apparatus 2 monitors the retransmission information, only the data information corresponding to the length of the front part needs to be extracted, this part is used as the second packet header information. Then the information operation module 1 only needs to perform a correlation operation on the data information corresponding to the length of the front part and the first packet header information, so that the calculation amount of the correlation operation may be reduced.

After receiving the forwarding drive signal, the transmitter module 3 forwards the rear part and the current audio data sequentially immediately, to keep in synchronization with the time sequence of the audio source device retransmitting the rear part and the current audio data. That is, after the switch 4 switched to the sending state, the transmitter module 3 immediately forwards the rear part and the immediately following forwarding packet data body part, so the timing can be kept synchronized with the retransmission of the audio source device retransmitting the rear part and the immediately following data body part.

In order to improve data receiving method and increase data error correction rate in the presence of deep fading signals caused by the human body, an embodiment of the present invention discloses a Bluetooth packet loss data receiver circuit. FIG. 12 is a schematic structural diagram of a Bluetooth communication receiver circuit according to an embodiment of the present invention. The Bluetooth communication receiver circuit is applied to a second audio playback device. A first audio playback device and the second audio playback device form an audio playback device pair, and the first audio playback device and the second audio playback device are configured to receive audio data from an audio source device respectively. In a specific embodiment, the first audio playback device and the second audio playback device form an audio playback device pair, for example, left and right earbuds or left and right channel speakers. The first audio playback device, the second audio playback device, and the audio source device form a dual wireless communication Bluetooth network. In an embodiment, the first audio playback device and the second audio playback device receive the audio data from the audio source device in receiving/monitoring mode. In another embodiment, the first audio playback device and the second audio playback device separately receive audio data from the audio source device. In this embodiment, data exchange may be further performed between the first audio playback device and the second audio playback device.

Referring to FIG. 12, the Bluetooth communication receiver circuit includes: an RF receiver apparatus B1, a common buffer B2, and an information processing module B3 that are connected sequentially.

When the second audio playback device fails to receive a current audio data packet, the RF receiver apparatus B1 monitors, on Link 1, retransmission information of the audio source device retransmitting the current audio data packet, and monitors, on Link 2, forwarding information of the first audio playback device forwarding the current audio data. In this embodiment, Link 1 is a link for the audio source device to send the audio data, and Link 2 is an interactive link between the first audio playback device and the second audio playback device.

FIG. 3 is a schematic diagram of an example of a user listening to audio signals from an audio source device according to an embodiment of the present invention A left earbud and a right earbud correspond to the first audio playback device and the second audio playback device, and a mobile phone corresponds to the audio source device. In specific implementation, each of the left earbud and the right earbud includes a transceiver antenna, the left earbud and the right earbud interact with the mobile phone via Link 1 (e.g. receiving or monitoring data sent by the mobile phone), and the left earbud interacts with the right earbud via Link 2. The mobile phone sends data to the left earbud and the right earbud according to a standard protocol. When the right earbud fails to receive or monitor the current audio data sent by the mobile phone, on the one hand, the second audio playback device may send a prompt information indicates that the current audio data was not successfully received, to the first audio playback device through Link 2; and on the other hand, the first audio playback device or the second audio playback device may send a Negative Acknowledgment (NACK) indicating that the current audio data was not successfully received, to the audio source device.

In this embodiment, on the one hand, when the first audio playback device obtains a forwarding request sent by the second audio playback device, the first audio playback device forwards the current audio data packet via Link 2 in the same preset frequency band as that of the audio source device. On the other hand, when the audio source device obtains a Negative Acknowledgment (NACK) indicating that the second audio playback device fails to receive the current audio data, the audio source device retransmits the current audio data packet in the preset frequency band via Link 1. Therefore, the retransmission information of the audio source device may be monitored on Link 1.

Based on the above analysis, on the one hand, the RF receiver apparatus B1 can analyze the monitored signal of the frequency band corresponding to Link 2 to determine whether the captured radio signal is sent by the first audio playback device. If the captured radio signal is sent by the first audio playback device, it may be considered that the forwarding information is monitored, that is, the first audio playback device is forwarding the current audio data packet. On the other hand, the RF receiver apparatus B1 can analyze the monitored signal of the frequency band corresponding to Link 1 to determine whether the captured radio signal is sent by the audio source device. If the captured radio signal is sent by the audio source device, it may be considered that the retransmission information is monitored, that is, the audio source device is retransmitting the current audio data packet.

The common buffer B2 is configured to buffer the data received on Link 1 when monitoring the retransmission information, and data received on Link 2 when monitoring the forwarding information, respectively. In this embodiment, after the monitored data of Link 1 and Link 2 is buffered through the common buffer B2, the buffered data can be analyzed to determine the correlation of the signals. In a specific implementation, each time a piece of data is monitored, the data can be buffered. It should be noted that, in a specific implementation, the common buffer B2 should be divided into two regions, and the two regions correspondingly buffer the data of Link 1 and the data of Link 2 respectively, to avoid data overlap and crossover.

The information processing module B3 is configured to calculate the data correlations based on the data of Link 1 and the data of Link 2 respectively and output a link selection control signal. In this embodiment, by calculating the data correlation by the information processing module B3, it may be determined whether the retransmission information and/or the forwarding information is monitored.

The RF receiver apparatus B1 is configured to select Link 1 and/or Link 2 as the target link(s) to receive the current audio data based on the link selection control signal, to perform error correction on the current packet loss data. In this embodiment, the link selected to receive the current audio data is the link on which the information is monitored. Specifically, since the locations of the audio source device and the first audio playback device are different, the audio source device and the first audio playback device are subject to different interference from the human body, that is, the signal strengths of communication with the second audio playback device is also different. In this embodiment, through the data correlation calculation result, it may be determined whether the current audio data of the audio source device and the first audio playback device can be received.

In a specific implementation,
when the data correlation calculation result of Link 1 is that there is a correlation, Link 1 is selected as the target link to receive the current audio data. That is, within a preset receiving bandwidth range, the current audio data retransmitted by the audio source device is received via Link 1;
when the data correlation calculation result of Link 2 is that there is a correlation, Link 2 is selected as the target link to receive the current audio data. That is, within the preset receiving bandwidth range, the current audio data forwarded by the first audio playback device is received via Link 2; or
when the data correlation calculation result of Link 1 is that there is a correlation and the data correlation calculation result of Link 2 is that there is a correlation, Link 1 and Link 2 are selected as the target links to receive the current audio data. That is, within the preset receiving bandwidth range, the current audio data retransmitted by the audio source device and the current audio data forwarded by the first audio playback device are simultaneously received.

In an optional embodiment, the current audio data is received on the target link in the same preset frequency band. That is, the first audio playback device forwards the current audio data by using the same preset frequency band as that of the audio source device. The second audio playback device receives the current audio data of the audio source device and the current audio data of the first audio playback device simultaneously in the same preset frequency band.

The preset frequency band may be determined empirically. Specifically, some frequency points in the preset frequency band can be used to receive the current data forwarded by the first audio playback device, and some other frequency points in the preset frequency band can be used to receive the current audio data retransmitted by the audio source device.

It should be noted that, in wireless communication, because the transceiver antenna may work in a frequency band composed of multiple frequency points in the same time period, based on this, in this embodiment, by allocating frequency points in the preset frequency band, the data from the first audio playback device and the audio source device can be simultaneously received, and there is no need to add additional hardware device, for example, no need to add additional antenna.

It should be noted that, “simultaneously” mentioned in this embodiment may chronologically mean specific leading or lagging in time points, rather than completely equal time points.

Referring to FIG. 12, in an optional embodiment, the information processing module B3 includes: a first information processing unit B31. The first packet header information is the packet header information of the audio source device. Please refer to FIG. 5A, FIG. 5B, and FIG. 5C, which are schematic diagrams of Bluetooth packet formats in a Bluetooth standard protocol. FIG. 5A is a schematic diagram of a BDR packet format in Bluetooth v2.1, FIG. 5B is a schematic diagram of an EDR packet format in Bluetooth v2.1, and FIG. 5C is a schematic diagram of a packet format in Bluetooth Low Energy. Generally speaking, Access code or Access address is packet header information provided for a Bluetooth receiver to perform synchronization, packet detection, and receiving alignment; and subsequent Header, Payload, or PDU has data information. In this embodiment, the packet header information of the audio source device is Access code or Access address. In specific implementation, the packet header information of the audio source device, for example, Access code or Access address may be stored locally, and therefore the stored packet header information can be directly extracted. Specifically, the first information processing unit B31 includes: a first buffer B311. The first buffer B311 is configured to store the first packet header information.

The common buffer B2 is configured to buffer the second packet header information obtained when the RF receiver apparatus B1 monitors the retransmission information. The second packet header information is packet header information of the signal received by the RF receiver apparatus B1. When the RF receiver apparatus B1 monitors a signal on Link 1, information extraction can be performed on the monitored signal to obtain the second packet header information. With the second packet header information, the identity of the signal sender can be confirmed, for example, by packet detection.

In a specific implementation, the first information processing unit B31 is configured to perform a correlation operation on the first packet header information and the second packet header information to obtain a retransmission correlation result. When the retransmission correlation result is greater than a first threshold, it is determined that Link 1 is the link on which the information is monitored. In a specific embodiment, the correlation operation such as convolution or matrix operation, etc., can be performed to obtain the retransmission correlation result. In this embodiment, the first threshold can be determined empirically. In this embodiment, if the retransmission correlation result is greater than the first threshold, it is determined that the retransmission information is monitored.

Referring to FIG. 12, the first information processing unit B31 includes: a first correlation subunit B312. An input end of the first correlation subunit B312 is connected to an output end of the first buffer B311 and an output end of the common buffer B2. The first correlation subunit B312 is configured to perform the correlation operation on the first packet header information and the second packet header information to obtain the retransmission correlation result. When the retransmission correlation result is greater than the first threshold, it is determined that Link 1 is the link on which the information is monitored. The first correlation subunit B312 can be implemented through a correlation calculation apparatus and a threshold determining apparatus. The correlation calculation apparatus may perform the correlation operation, such as convolution or matrix operation etc., to obtain the retransmission correlation result. The threshold determining apparatus can be implemented through a comparator circuit, etc.

In an embodiment, in order to reduce the amount of data operation, in an optional embodiment, the packet header information of the audio source device includes a front part and a rear t part, with the rear part lagging behind the front part in time sequence. The first buffer B311 is configured to store the front part, and the common buffer B2 is configured to buffer the data information corresponding to the length of the front part. That is, the packet header information of the audio source device is divided into two parts in time sequence: the front part and the rear part, wherein the front part used as the first packet header information is stored locally. When the retransmission information is monitored, only the data information corresponding to the length of the front part needs to be extracted, and this part is used as the second packet header information to do the correlation operation with the first packet header information, so that the calculation amount of the correlation operation can be reduced.

In another embodiment, considering the possibility of signal loss, in order to improve the integrity of the correlation operation, in an optional embodiment, the first packet header information is the complete packet header information of the audio source device, and the second packet header information is at least part of the complete packet header information. The first buffer B311 is configured to store the complete packet header information; and the data buffered in the common buffer B2 is at least part of the complete packet header information. That is, when partial information is monitored on Link 1 and buffered in the common buffer B2, a correlation operation can be performed on the partial information and the corresponding partial data in the first buffer B311, to obtain the retransmission correlation result. Therefore, misunderstanding that no retransmission information is monitored due to signal interference can be avoided.

Referring to FIG. 12, in an optional embodiment, the information processing module B3 includes: a second information processing unit B32. A third packet header information is stored locally. In this embodiment, the third packet header information is the packet header information of the audio source device. Please refer to FIG. 5A, FIG. 5B, and FIG. 5C, which are schematic diagrams of Bluetooth packet formats in a Bluetooth standard protocol. FIG. 5A is a schematic diagram of a BDR packet format in Bluetooth v2.1, FIG. 5B is a schematic diagram of an EDR packet format in Bluetooth v2.1, and FIG. 5C is a schematic diagram of a packet format in Bluetooth Low Energy. Generally speaking, Access code or Access address is the packet header information provided for a Bluetooth receiver to perform synchronization, packet detection, and receiving alignment; and the subsequent Header, Payload, or PDU has data information. In this embodiment, the packet header information of the audio source device is Access code or Access address. In specific implementation, the packet header information of the audio source device, for example, Access code or Access address can be stored locally, and therefore the stored packet header information can be directly extracted.

In a specific embodiment, the second information processing unit B32 includes: a second buffer B321. The second buffer B321 is configured to store the third packet header information.

It should be noted that, although the data packet is forwarded by the first audio playback device, it contains the packet header information of the audio source device because the data packet forwarded by the first audio playback device is the current audio data packet. Therefore, the third packet header information is the packet header information of the audio source device.

In this embodiment, the common buffer B2 is configured to buffer a fourth packet header information obtained when the RF receiver apparatus B1 monitors the forwarding information. The fourth packet header information is the packet header information of the signal received by the RF receiver apparatus B1. When the RF receiver apparatus B1 monitors the signal on Link 2, information extraction may be performed on the monitored signal to obtain the fourth packet header information. With the fourth packet header information, the identity of the signal sender can be confirmed, for example, by packet detection.

In a specific implementation, the second information processing unit B32 is configured to perform a correlation operation on the third packet header information and the fourth packet header information to obtain a forwarding correlation result, and determine that Link 2 is the link on which the information is monitored when the forwarding correlation result is greater than a second threshold. In this embodiment, the second threshold can be determined empirically. In this embodiment, if the forwarding correlation result is greater than the second threshold, it is determined that the forwarding information is monitored.

Referring to FIG. 12, in a specific embodiment, the second information processing unit B32 includes a second correlation subunit B322. An input end of the second correlation subunit B322 is connected to an output end of the second buffer B321 and an output end of the common buffer B2. In a specific implementation, the second correlation subunit B322 is configured to perform the correlation operation on the third packet header information and the fourth packet header information to obtain the forwarding correlation result, and determine that Link 2 is the link on which the information is monitored when the forwarding correlation result is greater than the second threshold. The second correlation subunit B322 can be implemented through a correlation calculation apparatus and a threshold determining apparatus. The correlation calculation apparatus can perform a correlation operation, such as convolution or matrix operation etc., to obtain the forwarding correlation result. The threshold determining apparatus can be implemented through a comparator circuit, etc.

In order to better perform data synchronization and reduce the amount of data operation, in an optional embodiment, the packet header information of the audio source device includes a front part and a rear part, with the rear part lagging behind the front part in time sequence. The second buffer B321 is configured to store the rear part, and the common buffer B2 is configured to buffer the data information corresponding to the length of the rear part. That is, the packet header information of the audio source device is divided into two parts in time sequence: a front part and a rear part, wherein the rear part used as the third packet header information is stored in the second buffer B321 locally. When the forwarding information is monitored, only the data information corresponding to the length of the rear part needs to be extracted and buffered in the common buffer B2. The second information processing unit B32 performs the correlation operation on the data information in the common buffer B2 used as the fourth packet header information and the third packet header information, so that the calculation amount of the correlation operation can be reduced.

It should be noted that, in this embodiment, since the first audio playback device forwards only the rear part and the immediately following retransmission packet data body part when forwarding audio data, only the rear part needs to be stored locally in the second buffer B321 as the third packet header information.

The present invention further discloses an audio playback device, including: a processor, configured to implement the Bluetooth packet loss data sending method or Bluetooth packet loss data receiving method disclosed in the foregoing embodiments.

The present invention further discloses an audio playback device, including: the Bluetooth communication transmitter circuit or receiver circuit disclosed in the foregoing embodiments.

The present invention further discloses an audio signal processing system, including: a first audio playback device and a second audio playback device, the first audio playback device and the second audio playback device being an audio playback device pair. The first audio playback device includes the apparatus disclosed in the foregoing embodiments, and the second audio playback device includes the apparatus disclosed in the foregoing embodiments; alternatively, the first audio playback device includes the circuit disclosed in the foregoing embodiments, and the second audio playback device includes the circuit disclosed in the foregoing embodiments. For example, the first audio playback device and the second audio playback device are a pair of earbuds. In another example, the first audio playback device and the second audio playback device are a pair of speakers.

In an optional embodiment, the audio signal processing system further includes:
an audio source device, configured to provide audio data to the first audio playback device and the second audio playback device.

The present invention further discloses a computer-readable storage medium, storing a computer program, wherein the computer program stored in the storage medium is executed to implement the method disclosed in the foregoing embodiments.

The present invention further discloses a chip for an audio device, having an integrated circuit thereon, wherein the integrated circuit is designed to implement the method disclosed in the foregoing embodiments, or having the circuit disclosed in the foregoing embodiments.

According to a method, circuit, audio playback device, and system for sending and receiving Bluetooth packet loss data disclosed in the embodiments of the present invention, a first audio playback device receives a forwarding request from a second audio playback device in a receiving state; monitors the retransmission information of an audio source device retransmitting a current audio data packet on Link 1 based on the forwarding request; switches from the receiving state to a sending state when the retransmission information is monitored; forwards the current audio data to the second audio playback device via Link 2 in accordance with the time sequence of the audio source device retransmitting the current audio data, wherein Link 2 is an interactive link between the first audio playback device and the second audio playback device. That is, in a process of the audio source device retransmitting the current audio data via Link 1, the first audio playback device can synchronously forward the current audio data via Link 2. Link 1 and Link 2 are in different spatial locations, so the signal can be provided to the second audio playback device from different locations. That is, in the case of packet loss error correction, the second audio playback device can obtain a better spatial diversity gain. In the presence of deep fading signal caused by the human body, the data receiving method is improved and the data error correction rate is increased.

According to a method, circuit, audio playback device, and system of receiving and sending Bluetooth packet loss data disclosed in the embodiments of the present invention, when a second audio playback device fails to receive the current audio data sent by an audio source device, the second audio playback device prompts a first audio playback device and the audio source device that the current audio data was not successfully received; monitors the retransmission information of the audio source device retransmitting the current audio data packet on Link 1; monitors the forwarding information of the first audio playback device forwarding the current audio data on Link 2; selects Link 1 and/or Link 2 as the target link(s) to receive the current audio data based on a retransmission determination result and a forwarding determination result, to perform error correction on the current packet loss data. The link selected to receive the current audio data is the link on which the information is monitored. That is, in a process of monitoring the current audio data retransmitted on Link 1, the second audio playback device synchronously monitors the current audio data forwarded on Link 2. Link 1 and Link 2 are in different spatial locations, the second audio playback device is subject to different interference by human body and different signal fading, so the second audio playback device can obtain the current audio data from different locations, and select the link on which the information is monitored as the target link to receive the current audio data. The way of the second audio playback device receiving the current audio data may be optimized. The data receiving method is improved, and the data error correction rate is increased in the presence of deep fading signals caused by the human body.

According to a method, circuit, audio playback device, and system of sending and receiving Bluetooth packet loss data disclosed in the embodiments of the present invention, an information operation module stores a first packet header information locally, where the first packet header information is the packet header information of an audio source device; a RF receiver apparatus is configured to monitor, through the Bluetooth antenna, retransmission information of the audio source device retransmitting an audio data packet to obtain a second packet header information, where the second packet header information is the packet header information of the signal received by the RF receiver apparatus; the information operation module is configured to perform a correlation operation on the first packet header information and the second packet header information to obtain a correlation result, and output a forwarding drive signal to a transmitter module when the correlation result is greater than a preset value; the transmitter module is configured to forward, based on the forwarding drive signal outputted by the information operation module, the current audio data to a second audio playback device in accordance with the time sequence of the audio source device retransmitting the current audio data. That is, the information operation module performs the correlation operation on the signal monitored by the RF receiver apparatus. When the correlation result is greater than the preset value, it indicates that the audio data packet being retransmitted by the audio source device is monitored, and then the forwarding drive signal is output to the transmitter module, so that the transmitter module forwards the current audio data to the second audio playback device in accordance with the time sequence of the audio source device retransmitting the current audio data. That is, the first audio playback device and the audio source device synchronously forward the current audio data to the second audio playback device. Because the first audio playback device and the audio source device are in different spatial locations, the signal may be provided to the second audio playback device from different locations. That is, in the case of packet loss error correction, the second audio playback device can obtain a better spatial diversity gain. The data receiving method is improved, and the data error correction rate is increased in the presence of deep fading signals caused by the human body.

According to a method, circuit, audio playback device, and system of sending and receiving Bluetooth packet loss data disclosed in the embodiments of the present invention, an RF receiver apparatus (B1), a common buffer (B2), and an information processing module (B3) are connected sequentially; when a second audio playback device fails to receive a current audio data packet, the RF receiver apparatus (B1) monitors, on Link 1, retransmission information of an audio source device retransmitting the current audio data packet, and monitors, on Link 2, forwarding information of a first audio playback device forwarding the current audio data; the common buffer (B2) is configured to buffer data of Link 1 and data of Link 2, respectively; the information processing module (B3) is configured to calculate data correlations based on the data of Link 1 and the data of Link 2, respectively, and output a link selection control signal; the RF receiver apparatus (B1) is configured to select, according to the link selection control signal, the link on which information is monitored as the target link(s) to receive the current audio data. That is, the audio source device and the first audio playback device send the current audio data simultaneously. The audio source device and the first audio playback device are in different spatial locations, and subject to different interference by the human body and different signal fading. Therefore, it is possible to obtain the current audio data from different locations. In a process of monitoring the current audio data retransmitted via Link 1, the information processing module (B3) synchronously monitors the current audio data forwarded via Link 2; calculates the data correlations based on the data of Link 1 and the data of Link 2 respectively; and determines the link on which the information is monitored to receive the current audio data. The way of the second audio playback device receiving the current audio data can be optimized. The data receiving method is improved, and the data error correction rate is increased in the presence of deep fading signals caused by the human body.

It should be noted that, step numbers (letter or digit number) used in the present invention to refer to certain specific method steps, are only intended to make description convenient and brief, rather than to limit the order of these method steps with letters or digits. A person skilled in the art can understand that, the order of relevant method steps should be decided by the technology itself, and should not be unduly limited by the presence of step numbers.

A person skilled in the art can understand that, the foregoing preferable solutions may be freely combined and superimposed without conflict.

It should be understood that, the above embodiments are merely illustrative instead of restrictive, and those skilled in the art can make a variety of obvious or equivalent modifications or replacements to the above details without departing from the basic principle of the present invention, and all these modifications and replacements will be included in the scope of the claims of the present invention.

What is claimed is:

1. A method of sending Bluetooth packet loss data, applied to a first audio playback device, wherein the first audio playback device and a second audio playback device form an audio playback device pair, and the first audio playback device and the second audio playback device are configured to separately receive audio data from an audio source device, comprising:
step S100, receiving, in a receiving state, a forwarding request sent by the second audio playback device, wherein the forwarding request indicates that the second audio playback device fails to receive current audio data sent by the audio source device;
step S200, monitoring, on Link 1 based on the forwarding request, retransmission information of the audio source device retransmitting the current audio data, wherein Link 1 is the link for the voice source device to send audio data;
step S300, determining whether the retransmission information is monitored; wherein if the retransmission information is monitored, step S400 and step S500 are performed sequentially;
step S400, switching from the receiving state to a sending state; and
step S500, forwarding the current audio data to the second audio playback device through Link 2 in accordance with the time sequence of the audio source device retransmitting the current audio data, wherein Link 2 is the interactive link between the first audio playback device and the second audio playback device.

2. The method of sending Bluetooth packet loss data according to claim 1, wherein in step S500, the current audio data is forwarded by using the same preset frequency band as that of the audio source device.

3. The method of sending Bluetooth packet loss data according to claim 1, wherein step S300 comprises:
step S310, extracting a first packet header information that is stored locally, wherein the first packet header information is the packet header information of the audio source device;
step S320, performing information extraction on a signal monitored on Link 1 to obtain a second packet header information;
step S330, performing a correlation operation on the first packet header information and the second packet header information to obtain a correlation result; and
step S340, determining whether the correlation result is greater than a preset value, and determining, if the correlation result is greater than the preset value, that the retransmission information is monitored.

4. The method of sending Bluetooth packet loss data according to claim 3, wherein the packet header information of the audio source device comprises a front part and a rear part, with the rear part lagging behind the front part in time sequence; and the first packet header information is the front part, and the second packet header information is data information corresponding to the length of the front part.

5. The method of sending Bluetooth packet loss data according to claim 1, wherein in step S500, after switching to the sending state, the rear part and the current audio data are forwarded sequentially immediately, to keep in synchronization with the time sequence of the audio source device retransmitting the rear part and the current audio data.

6. A method of receiving Bluetooth packet loss data, applied to a second audio playback device, wherein a first audio playback device and the second audio playback device form an audio playback device pair, and the first audio playback device and the second audio playback device are configured to separately receive audio data from an audio source device, comprising:
step R100, prompting, when the second audio playback device fails to receive current audio data sent by the audio source device, the first audio playback device and the audio source device that the second audio playback device fails to receive the current audio data;
step R200, monitoring, on Link 1, retransmission information of the audio source device retransmitting the current audio data, wherein Link 1 is the link for the audio source device to send audio data;
step R300, monitoring, on Link 2, forwarding information of the first audio playback device forwarding the current audio data, wherein Link 2 is the interactive link between the first audio playback device and the second audio playback device;
step R400, determining whether the retransmission information is monitored, to obtain a retransmission determination result;
step R500, determining whether the forwarding information is monitored, to obtain a forwarding determination result; and
step R600, selecting, based on the retransmission determination result and the forwarding determination result, Link 1 and/or Link 2 as the target link(s) to receive the current audio data, to perform error correction on current packet loss data.

7. The method of receiving Bluetooth packet loss data according to claim 6, wherein step R400 comprises:
step R410, extracting a first packet header information that is stored locally, wherein the first packet header information is the packet header information of the audio source device;
step R420, performing information extraction on a signal monitored on Link 1 to obtain a second packet header information;
step R430, performing a correlation operation on the first packet header information and the second packet header information to obtain a retransmission correlation result; and
step R440, determining whether the retransmission correlation result is greater than a preset value, and determining, if the retransmission correlation result is greater than a preset value, that the retransmission information is monitored.

8. The method of receiving Bluetooth packet loss data according to claim 7, wherein the packet header information of the audio source device comprises a front part and a rear part, with the rear part lagging behind the front part in time sequence; and the first packet header information is the front part, and the second packet header information is data information corresponding to the length of the front part.

9. The method of receiving Bluetooth packet loss data according to claim 7, wherein the first packet header information is a complete packet header information of the audio source device, and the second packet header information is at least a part of the complete packet header information.

10. The method of receiving Bluetooth packet loss data according to claim 6, wherein step R500 comprises:
step R510, extracting a third packet header information that is stored locally, wherein the third packet header information is the packet header information of the audio source device;
step R520, performing information extraction on a signal monitored on Link 2 to obtain a fourth packet header information;
step R530, performing a correlation operation on the third packet header information and the fourth packet header information to obtain a forwarding correlation result; and
step R540, determining whether the forwarding correlation result is greater than a preset value, and determining, if the forwarding correlation result is greater than the preset value, that the forwarding information is monitored.

11. The method of receiving Bluetooth packet loss data according to claim 10, wherein the packet header information of the audio source device comprises a front part and a rear part, with the rear part lagging behind the front part in time sequence; and the third packet header information is the rear part, and the fourth packet header information is data information corresponding to the length of the rear part.

12. The method of receiving Bluetooth packet loss data according to claim 6, wherein step R600 comprises:
selecting, when the retransmission determination result is that the retransmission information is monitored, Link 1 as the target link to receive the current audio data; or
selecting, when the forwarding determination result is that the forwarding information is monitored, Link 2 as the target link to receive the current audio data; or
selecting, when the retransmission determination result is that the retransmission information is monitored and the forwarding determination result is that the forwarding information is monitored, Link 1 and Link 2 as the target links to receive the current audio data.

13. The method of receiving Bluetooth packet loss data according to claim 12, wherein the current audio data is received on the target link in the same preset frequency band.

14. A Bluetooth packet loss data sending apparatus, applied to a first audio playback device, wherein the first audio playback device and a second audio playback device form an audio playback device pair, and the first audio playback device and the second audio playback device are configured to separately receive audio data from an audio source device, comprising:
a request receiving module (100), configured to receive, in a receiving state, a forwarding request sent by the second audio playback device, wherein the forwarding request indicates that the second audio playback device fails to receive current audio data sent by the audio source device;
a retransmission monitoring module (200), configured to monitor, on Link 1 based on the forwarding request, retransmission information of the audio source device retransmitting the current audio data, wherein Link 1 is the link for the audio source device to send audio data;
a retransmission determining module (300), configured to determine whether the retransmission information is monitored, wherein if the retransmission information is monitored, a state switching module (400) and a forwarding module (500) are operated sequentially;
the state switching module (400), configured to switch from the receiving state to a sending state; and
the forwarding module (500), configured to forward the current audio data to the second audio playback device through Link 2 in accordance with the time sequence of the audio source device retransmitting the current audio data, wherein Link 2 is the interactive link between the first audio playback device and the second audio playback device.

15. The Bluetooth packet loss data sending apparatus according to claim 14, wherein the forwarding module (500) is configured to forward the current audio data by using the same preset frequency band as that of the audio source device.

16. The Bluetooth packet loss data sending apparatus according to claim 14, wherein the retransmission determining module (300) comprises:
a first extraction unit, configured to extract a first packet header information that is stored locally, wherein the first packet header information is the packet header information of the audio source device;
a second extraction unit, configured to perform information extraction on a signal monitored on Link 1 to obtain a second packet header information;
a correlation operation unit, configured to perform a correlation operation on the first packet header information and the second packet header information to obtain a correlation result; and
a preset value determining unit, configured to determine whether the correlation result is greater than a preset value, and determine, if the correlation result is greater than the preset value, that the retransmission information is monitored.

17. The Bluetooth packet loss data sending apparatus according to claim 16, wherein the packet header information of the audio source device comprises a front part and a rear part, with the rear part lagging behind the front part in time sequence; and the first packet header information is the front part, and the second packet header information is data information corresponding to the length of the front part.

18. The Bluetooth packet loss data sending apparatus according to claim 17, wherein the forwarding module (500) is configured to forward, after switching to the sending state, the rear part and the current audio data sequentially immediately, to keep in synchronization with the time sequence of the audio source device retransmitting the rear part and the current audio data.

19. A Bluetooth packet loss data receiving apparatus, applied to a second audio playback device, wherein a first audio playback device and the second audio playback device form an audio playback device pair, and the first audio playback device and the second audio playback device are configured to separately receive audio data from an audio source device, comprising:
a prompting module (10), configured to prompt, when the second audio playback device fails to receive the current audio data sent by the audio source device, the first audio playback device and the audio source device that the second audio playback device fails to receive the current audio data;
a first intercepting module (20), configured to monitor, on Link 1, retransmission information of the audio source device retransmitting the current audio data, wherein Link 1 is the link for the audio source device to send audio data;
a second intercepting module (30), configured to monitor, on Link 2, forwarding information of the first audio playback device forwarding the current audio data, wherein Link 2 is the interaction link between the first audio playback device and the second audio playback device;
a first determining module (40), configured to determine whether the retransmission information is monitored, to obtain a retransmission determination result;
a second determining module (50), configured to determine whether the forwarding information is monitored, to obtain a forwarding determination result; and
a data receiving module (60), configured to select, according to the retransmission determination result and the forwarding determination result, Link 1 and/or Link 2 as the target link(s) to receive the current audio data, to perform error correction on current packet loss data.

20. The Bluetooth packet loss data receiving apparatus according to claim 19, wherein the first determining module (40) comprises:
a first extraction unit, configured to extract a first packet header information that is stored locally, wherein the first packet header information is the packet header information of the audio source device;
a second extraction unit, configured to perform information extraction on a signal monitored on Link 1 to obtain a second packet header information;
a retransmission correlation operation unit, configured to perform a correlation operation on the first packet header information and the second packet header information to obtain a retransmission correlation result; and
a first determining unit, configured to determine whether the retransmission correlation result is greater than a preset value, and determine, if the retransmission correlation result is greater than the preset value, that the retransmission information is monitored.

21. The Bluetooth packet loss data receiving apparatus according to claim 20, wherein the packet header information of the audio source device comprises a front part and a rear part, with the rear part lagging behind the front part in time sequence; and the first packet header information is the front part, and the second packet header information is data information corresponding to the length of the front part.

22. The Bluetooth packet loss data receiving apparatus according to claim 20, wherein the first packet header information is a complete packet header information of the audio source device, and the second packet header information is at least a part of the complete packet header information.

23. The Bluetooth packet loss data receiving apparatus according to claim 19, wherein the second determining module (50) comprises:
a third extraction unit, configured to extract a third packet header information that is stored locally, wherein the third packet header information is packet header information of the audio source device;
a fourth extraction unit, configured to perform information extraction on a signal monitored on Link 2 to obtain a fourth packet header information;
a forwarding correlation operation unit, configured to perform a correlation operation on the third packet header information and the fourth packet header information to obtain a forwarding correlation result; and
a second determining unit, configured to determine whether the forwarding correlation result is greater than a preset value, and determine, if the forwarding correlation result is greater than the preset value, that the forwarding information is monitored.

24. The Bluetooth packet loss data receiving apparatus according to claim 23, wherein the packet header information of the audio source device comprises a front part and a rear part, with the rear part lagging behind the front part in time sequence; wherein the third packet header information is the rear part, and the fourth packet header information is the data information corresponding to the length of the rear part.

25. The Bluetooth packet loss data receiving apparatus according to claim 19, wherein the data receiving module (60) is further configured to:
select, when the retransmission determination result is that the retransmission information is monitored, Link 1 as the target link to receive the current audio data; or
select, when the forwarding determination result is that the forwarding information is monitored, Link 2 as the target link to receive the current audio data; or
select, when the retransmission determination result is that the retransmission information is monitored and the forwarding determination result is that the forwarding information is monitored, Link 1 and Link 2 as the target links to receive the current audio data.

26. The Bluetooth packet loss data receiving apparatus according to claim 25, wherein the current audio data is received on the target link in the same preset frequency band.

27. A Bluetooth communication transmitter circuit, applied to a first audio playback device, wherein the first audio playback device and a second audio playback device form an audio playback device pair, and the first audio playback device and the second audio playback device are configured to separately receive audio data from an audio source device, comprising:
an information operation module (1), configured to store a first packet header information locally, wherein the first packet header information is the packet header information of the audio source device;
an RF receiver apparatus (2), having an input end connected to a Bluetooth antenna, an output end connected to the information operation module (1); wherein the RF receiver apparatus (1) is configured to monitor, through the Bluetooth antenna, retransmission information of the audio source device retransmitting current audio data to obtain a second packet header information, wherein the second packet header information is the packet header information of the signal received by the RF receiver apparatus (1); and
a transmitter module (3), connected to the information operation module (1), wherein the transmitter module (3) is configured to forward, based on a forwarding drive signal outputted by the information operation module (1), the current audio data to the second audio playback device in accordance with the time sequence of the audio source device retransmitting the current audio data; and
the information operation module (1), configured to perform a correlation operation on the first packet header information and the second packet header information to obtain a correlation result, and output the forwarding drive signal to the transmitter module (3) when the correlation result is greater than a preset value.

28. The Bluetooth communication transmitter circuit according to claim 27, wherein the transmitter module (3) is configured to forward the current audio data by using the same preset frequency band as that of the audio source device.

29. The Bluetooth communication transmitter circuit according to claim 27, wherein the information operation module (1) comprises:
a first buffer (11), configured to store the first packet header information;
a second buffer (12), connected to the output end of the RF receiver apparatus (2), wherein the second buffer (12) is configured to buffer the second packet header information; and
a correlation unit (13), having an input end connected to an output end of the first buffer (11) and an output end of the second buffer (12), and an output end connected to the transmitter module (3); wherein the correlation unit (13) is configured to perform the correlation operation on the first packet header information and the second packet header information to obtain the correlation result, and output the forwarding drive signal to the transmitter module (3) when the correlation result is greater than the preset value.

30. The Bluetooth communication transmitter circuit according to claim 27, further comprising:
a switch (4), having an end connected to the Bluetooth antenna, and the other end selectively connected to the RF receiver apparatus (2) or the transmitter module (3), wherein
when the other end of the switching switch (4) is connected to the RF receiver apparatus (2), the RF receiver apparatus (2) monitors the retransmission information through the Bluetooth antenna; and
when the other end of the switching switch (4) is connected to the transmitter module (3), the transmitter module (3) forwards the current audio data through the Bluetooth antenna.

31. The Bluetooth communication transmitter circuit according to claim 29, wherein
the packet header information of the audio source device comprises a front part and a rear part, with the rear part lagging behind the front part in time sequence;
the first buffer (11) is configured to store the front part; and
the second buffer (12) is configured to buffer the data information in the second packet header information corresponding to the length of the front part.

32. The Bluetooth communication transmitter circuit according to claim 31, wherein
the transmitter module (3) forwards, after receiving the forwarding drive signal, the rear part and the current audio data sequentially immediately, to keep in synchronization with the time sequence of the audio source device retransmitting the rear part and the current audio data.

33. The Bluetooth communication transmitter circuit according to claim 27, wherein the packet header information of the audio source device is ACCESS CODE data or ACCESS ADDRESS data in a standard protocol.

34. A Bluetooth communication receiver circuit, applied to a second audio playback device, wherein a first audio playback device and the second audio playback device form an audio playback device pair, and the first audio playback device and the second audio playback device are configured to separately receive audio data from an audio source device, comprising:
a RF receiver apparatus (B1), a common buffer (B2), and an information processing module (B3) that are connected sequentially, wherein
when the second audio playback device fails to receive the current audio data, the RF receiver apparatus (B1) monitors, on Link 1, retransmission information of the audio source device retransmitting the current audio data, and monitors, on Link 2, forwarding information of the first audio playback device forwarding the current audio data, wherein Link 1 is the link for the audio source device to send audio data; and Link 2 is the interaction link between the first audio playback device and the second audio playback device;
the common buffer (B2) is configured to buffer data of Link 1 received when monitoring the retransmission information, and data of Link 2 received when monitoring the forwarding information, respectively;
the information processing module (B3) is configured to calculate data correlations based on the data of Link 1 and the data of Link 2 respectively and output a link selection control signal; and
the RF receiver apparatus (B1) is configured to select, according to the link selection control signal, Link 1 and/or Link 2 as the target link(s) to receive the current audio data, to perform error correction on current packet loss data, wherein the link selected to receive the current audio data is the link on which information is monitored.

35. The Bluetooth communication receiver circuit according to claim 34, wherein
the common buffer (B2) is configured to buffer a second packet header information obtained when the RF receiver apparatus (B1) monitors the retransmission information, wherein the second packet header information is the packet header information of the signal received by the RF receiver apparatus (1); and
the information processing module (B3) comprises:
a first information processing unit (B31), configured to store a first packet header information locally, wherein the first packet header information is the packet header information of the audio source device; and the first information processing unit (B31) is configured to perform a correlation operation on the first packet header information and the second packet header information to obtain a retransmission correlation result, and determine, when the retransmission correlation result is greater than a first threshold, that Link 1 is the link on which information is monitored.

36. The Bluetooth communication receiver circuit according to claim 35, wherein the first information processing unit (B31) comprises:
a first buffer (B311), configured to store the first packet header information; and
a first correlation subunit (B312), having an input end connected to an output end of the first buffer (B311) and an output end of the common buffer (B2), wherein the first correlation subunit (B312) is configured to perform a correlation operation on the first packet header information and the second packet header information to obtain a retransmission correlation result, and determine, when the retransmission correlation result is greater than a first threshold, that Link 1 is the link on which information is monitored.

37. The Bluetooth communication receiver circuit according to claim 36, wherein the packet header information of the audio source device comprises a front t part and a rear part, with the rear part lagging behind the front part in time sequence; and
the first buffer (B311) is configured to store the front part, and the common buffer (B2) is configured to buffer the data information corresponding to the length of the front part.

38. The Bluetooth communication receiver circuit according to claim 36, wherein the first packet header information is a complete packet header information of the audio source device; and
the first buffer (B311) is configured to store the complete packet header information; and the data buffered in the common buffer (B2) is at least a part of the complete packet header information.

39. The Bluetooth communication receiver circuit according to claim 34, wherein
the information processing module (B3) comprises:
a second information processing unit (B32), configured to store a third packet header information locally, wherein the third packet header information is packet header information of the audio source device;
wherein the common buffer (B2) is configured to buffer a fourth packet header information obtained when the RF receiver apparatus (B1) monitors the forwarding information, wherein the fourth packet header information is the packet header information of the signal received by the RF receiver apparatus (1);
wherein the second information processing unit (B32) is configured to perform a correlation operation on the third packet header information and the fourth packet header information to obtain a forwarding correlation result, and determine, when the forwarding correlation result is greater than a second threshold, that Link 2 is the link on which information is monitored.

40. The Bluetooth communication receiver circuit according to claim 39, wherein the second information processing unit (B32) comprises:
a second buffer (B321), configured to store the third packet header information; and
a second correlation subunit (B322), having an input end connected to an output end of the second buffer (B321) and an output end of the common buffer (B2), wherein
the second correlation subunit (B322) is configured to perform the correlation operation on the third packet header information and the fourth packet header information to obtain the forwarding correlation result, and determine, when the forwarding correlation result is greater than the second threshold, that Link 2 is the link on which information is monitored.

41. The Bluetooth communication receiver circuit according to claim 39, wherein the packet header information of the audio source device comprises a front part and a rear part, with the rear part lagging behind the front part in time sequence; and
the second buffer (B321) is configured to store the rear part, and the common buffer (B2) is configured to buffer the data information corresponding to the length of the rear part.

42. The Bluetooth communication receiver circuit according to claim 34, wherein
when information is monitored on both Link 1 and Link 2, the RF receiver apparatus (B1) receives, via Link 1 in a preset frequency band, the current audio data retransmitted by the audio source device, and simultaneously receives, via Link 2 in the same preset frequency band, the current audio data forwarded by the first audio playback device.

43. An audio playback device, comprising:
a processor, configured to implement the method according to claim 1.

44. An audio playback device, comprising:
the circuit according to claim 27.

45. A computer-readable storage medium, storing a computer program, wherein the computer program stored in the storage medium is executed to implement the method according to claim 1.

46. A chip for an audio device, comprising an integrated circuit thereon, wherein the integrated circuit is designed to implement the method according to claim 1.
